(19) United States
(12) Patent Application Publication
(10) Pub. No.: US 2006/0054425 A1
(43) Pub. Date: Mar. 16, 2006

(54) Floating caliper-type disc brake

(75) Inventor: Toshifumi Maehara, Tokyo (JP)

Correspondence Address: MORGAN LEWIS & BOCKIUS LLP, 1111 PENNSYLVANIA AVENUE NW, WASHINGTON, DC, 20004, US

(73) Assignee: AKEBONO BRAKE INDUSTRY CO., LTD.

(21) Appl. No.: 11/203,145

(22) Filed: Aug. 15, 2005

(30) Foreign Application Priority Data
Aug. 19, 2004 (JP) P. 2004-239882

(51) Int. Cl. F16D 55/00

(52) U.S. Cl. 188/71.1

(57) ABSTRACT

A support member 3a for supporting a caliper 2a and pads 10a and 10b includes an inner-side mounting member 17 disposed inwardly of an inner side of a rotor, and a torque receiving member 18 which is separate from the inner-side mounting member 17. The inner-side mounting member 17 and the torque receiving member 18 are connected together by bolts 21 at a position disposed radially outwardly of an outer peripheral edge of the rotor. With this construction, the inner-side mounting member 17 and the torque receiving member 18 can be formed respectively into simple shapes, and besides an operation for machining the torque receiving member 18 can be easily carried out. By doing so, the above problem can be solved.

### CROSS REFERENCE TO RELATED APPLICATIONS

The present application claims foreign priority based on Japanese Patent Application No. P.2004-239882, filed on Aug. 19, 2004, the contents of which are incorporated herein by reference.

### BACKGROUND OF THE INVENTION

1. Field of the Invention

The present invention relates to a floating caliper type disc brake for braking an automobile.

2. Related Art

As a disc brake for braking an automobile, there is a floating caliper type disc brake in which a caliper is supported on a support member so as to move in an axial direction, and a cylinder and a piston are provided only on one side of a rotor.

In the floating caliper type disc brakes, there are various types different in a method of retaining the caliper and a method of sliding the caliper. For example, in a structure called as a pin slide type (which is currently the mainstream), a caliper is movably supported on a support member by a pair of guide pins. FIGS. 21 and 22 show such a pin slide-type structure disclosed in JP-A-03-194224. In the pin slide-type floating caliper type disc brake, the caliper 2 is movable relative to a rotor 1 (which rotates with a wheel (not shown)) when the braking is effected. For mounting the disc brake on a vehicle, a support member 3, provided adjacent to one side of the rotor 1, is fixed to a vehicle body (not shown) through mounting holes 4. The caliper 2 is supported on the support member 3 so as to be displaced in an axial direction.

Therefore, a pair of guide pins 5 are provided respectively at opposite end portions (with respect to a direction of rotation of the rotor 1) of the caliper 2 in parallel relation to a center axis of the rotor 1, and similarly a pair of guide holes 6 are formed respectively in opposite end portions of the support member 3 in parallel relation to the center axis of the rotor 1. The two guide pins 5 are inserted respectively in the two guide holes 6 so as to slide in the axial direction of the rotor 1. A dust-proof boot 7 is provided between an outer peripheral surface of a proximal end portion of each of the two guide pins 5 and an open end of the corresponding guide hole 6.

A run-in side engagement portion 8 and a run-out side engagement portion 9 are provided respectively at the opposite end portions of the support member 3, and are spaced from each other in a circumferential direction of the rotor 1. Each of the engagement portions 8 and 9 is bent into a U-shape at its distal end portion, and straddles an outer peripheral portion of the rotor 1 in an upward-downward direction (in FIG. 21). Opposite end portions of each of back plates 11 and 11 for pads 10a and 10b are engaged respectively with the two engagement portions 8 and 9 so as to slide in the axial direction of the rotor 1. There is provided the caliper 2 including a cylinder portion 12 and a claw portion 13 which are interconnected by a bridge portion 54 straddling the pads 10a and 10b. A piston 14 for pressing the inner-side (inner side in a direction of the width of the vehicle; upper side in FIG. 21) pad 10a against the rotor 1 is fitted liquid-tight in the cylinder portion 12 of the caliper 2.

For effecting a braking operation, pressurized oil is supplied into the cylinder portion 12, so that a lining 15 of the inner pad 10a is pressed downward (in FIG. 21) against the inner side or face of the rotor 1. At this time, as a reaction of this pressing force, the caliper 2 is displaced upward (in FIG. 21) through the sliding movement of the guide pins 5 along the respective guide holes 6, so that the claw portion 13 presses a lining 15 of the outer-side (outer side in the direction of the width of the vehicle; lower side in FIG. 21) pad 10b against the outer side of the rotor 1. As a result, the rotor 1 is strongly held between the two pads, thus effecting the braking.

In the case of the above structure shown in FIGS. 21 and 22, the mounting holes 4 for mounting the support member 3 on the vehicle body are formed in the inner side (with respect to the rotor 1) of the support member 3, and more specifically are formed respectively in those portions of the support member 3 which are disposed radially inwardly of the outer peripheral edge of the rotor 1. The pair of pads 10a and 10b are supported respectively at the inner and outer side portions (with respect to the rotor 1) of the support member 3 so as to slide in the axial direction of the rotor 1. Therefore, the support member 3 straddles the outer peripheral portion of the rotor 1 in the axial direction of this rotor 1. In the case where this support member 3 is formed into an integral construction by casting or the like, its shape is considerably complicated, and an operation for machining part of this support member 3 is considerably cumbersome. Namely, retaining portions 72 for supporting the opposite end portions of the pads 10a and 10b are formed at the inner and outer sides of the support member 3, and it is necessary to machine these retaining portions 72. However, in the conventional structure, the shape of the support member 3 is complicated as describe above, and therefore this machining operation is considerably cumbersome. This has been the cause of an increased overall cost of the disc brake.

I the case of the above pin slide-type structure shown in FIGS. 21 and 22, the sliding contact portions of the guide pins 5 and guide holes 6 (which enable the caliper 2 to be displaced relative to the support member 3 in the axial direction of the rotor 1) are not exposed to the exterior, and therefore a problem, resulting from the development of rust on those portions exposed to the exterior, is less liable to arise. In the above pin slide-type structure, however, a cumbersome operation for machining an inner peripheral surface of each guide hole 6 with high precision is required. And besides, many parts, including the pair of guide pins 5 and a pair of bolts 16 and 16 for connecting the guide pins 5 to the caliper 2, are necessary, and this has further increased the overall production cost of the disc brake.

Furthermore, in the case of the above pin slide-type structure shown in FIGS. 21 and 22, the opposite end portions of each of back plates 15 and 15 for the pads 10a and 10b are engaged with the run-inside and run-outside engagement portions 8 and 9, respectively. Braking torques, developing respectively at the pads 10a and 10b at the time of the braking operation, are supported by the run-out side engagement portion 9 out of the two engagement portions 8 and 9. At this time, there is a possibility that the run-out side engagement portion 9 is deformed in the direction of rotation of the rotor 1. When the run-out side engagement portion 9 is thus deformed, the guide pin, inserted in the guide hole formed in the run-out side engagement portion 9, is inclined relative to the direction of the axis of the rotor 1 (partly because those portions of the support member 3, fixed to the vehicle body, are disposed inwardly of the inner side of the rotor 1), and this leads to a possibility that wear of the outer pad 10b proceeds earlier (that is, the amount of wear becomes larger) at its rotor run-out side-portion (right-side portion in FIG. 21) than at its rotor run-in side portion (left-side portion in FIGS. 21 and 22). Also, there is a possibility that wear of the inner pad 10a proceeds earlier at its rotor run-in side portion than at its rotor run-out side portion.

Further, JP-U-52-080389 also discloses the prior art.

### SUMMARY OF THE INVENTION

One or more embodiments of the present invention provides a floating caliper type disc brake in which a support member comprises members which have simple shapes, respectively, so that an operation for machining the support member can be easily carried out, thereby reducing the cost.

As a first aspect of the invention, in accordance with one or more embodiments of the present invention, a floating caliper type disc brake is provided with: a support member which is fixed to a vehicle body, and is disposed adjacent to a rotor rotatable with a wheel; a pair of pads disposed respectively on opposite sides of the rotor; a caliper which is supported on the support member so as to be displaced in an axial direction of the rotor; a claw portion provided at that portion of the caliper disposed at one side of a bridge portion of the caliper straddling the rotor; and a piston fitted in that portion of the caliper disposed at the other side of the bridge portion. When the piston is pushed out, the pair of pads are pressed respectively against the opposite sides of the rotor, thereby effecting a braking operation. In the floating caliper type disc brake, the support member is provided with at least an inner-side mounting member disposed inwardly of the inner side of the rotor in the axial direction of the rotor, and at least one member separate from the inner-side mounting member, and the inner-side mounting member and the separate member are connected together at a position disposed radially outwardly of an outer peripheral edge of the rotor.

As a second aspect of the invention, in accordance with one or more embodiments of the present invention, the inner-side mounting member is formed by a plate material having a uniform thickness.

As a third aspect of the invention, in accordance with one or more embodiments of the present invention, a floating caliper type disc brake is provided with: a support member which is fixed to a vehicle body, and is disposed adjacent to a rotor rotatable with a wheel; a pair of pads disposed respectively on opposite sides of the rotor; a caliper which is supported on the support member and the pads by guide portions, formed at the support member and the pads, and a guide member, fitted in the guide portions of the pads, in such a manner that the caliper can be displaced in an axial direction of the rotor; a claw portion provided at that portion of the caliper disposed at one side of a bridge portion of the caliper straddling the rotor; and a piston fitted in that portion of the caliper disposed at the other side of the bridge portion. When the piston is pushed out, the pair of pads are pressed respectively against the opposite sides of the rotor, thereby effecting a braking operation. In the floating caliper type disc brake, the support member comprises a torque receiving member which receives a torque (acting in a direction of rotation of the rotor) from the pads during the braking operation at a position disposed radially outwardly of an outer peripheral edge of the rotor, and an outer-side reinforcing member disposed outwardly of the outer side of the rotor in the axial direction of the rotor.

As a fourth aspect of the invention, in accordance with one or more embodiments of the present invention, the torque receiving member and the outer-side reinforcing member are connected together at a position disposed radially outwardly of the outer peripheral edge of the rotor.

As a fifth aspect of the invention, in accordance with one or more embodiments of the present invention, the outer-side reinforcing member is formed by a plate material having a uniform thickness.

As a sixth aspect of the invention, in accordance with one or more embodiments of the present invention, the torque receiving member can be connected to the vehicle body at a position disposed radially outwardly of the outer peripheral edge of the rotor.

As a seventh aspect of the invention, in accordance with one or more embodiments of the present invention, a floating caliper type disc brake is provided with: a support member which is fixed to a vehicle body, and is disposed adjacent to a rotor rotatable with a wheel; a pair of pads disposed respectively on opposite sides of the rotor; a caliper which is supported on the support member and the pads by guide portions, formed at the support member and the pads, and a guide member, fitted in the guide portions of the pads, in such a manner that the caliper can be displaced in an axial direction of the rotor; a claw portion provided at that portion of the caliper disposed at one side of a bridge portion of the caliper straddling the rotor; and a piston fitted in that portion of the caliper disposed at the other side of the bridge portion. When the piston is pushed out, the pair of pads are pressed respectively against the opposite sides of the rotor, thereby effecting a braking operation. In the flpating caliper tye disc brake, the support member comprises at least an inner-side mounting member disposed inwardly of the inner side of the rotor in the axial direction of the rotor, and a torque receiving member which receives a torque (acting in a direction of rotation of the rotor) from the pads during the braking operation; and the inner-side mounting member and the torque receiving member are connected together by fixing means or fastening means.

As an eighth aspect of the invention, in accordance with one or more embodiments of the present invention, a floating caliper type disc brake is provided with a support member which is fixed to a vehicle body, and is disposed adjacent to a rotor rotatable with a wheel; a pair of pads disposed respectively on opposite sides of the rotor; a caliper which is supported on the support member and the pads by guide portions, formed at the support member and the pads, and a guide member, fitted in the guide portions of the pads, in such a manner that the caliper can be displaced in an axial direction of the rotor; a claw portion provided at that portion of the caliper disposed at one side of a bridge portion of the caliper straddling the rotor; and a piston fitted in that portion of the caliper disposed at the other side of the bridge portion. When the piston is pushed out, the pair of pads are pressed respectively against the opposite sides of the rotor, thereby effecting a braking operation. In the floating caliper type disc brake, the support member comprises at least a torque receiving member which receives a torque (acting in a direction of rotation of the rotor) from the pads during the braking operation, and an outer-side reinforcing member disposed outwardly of the outer side of the rotor in the axial direction of the rotor; and the torque receiving member and the outer-side reinforcing member are connected together by fixing means or fastening means.

As a ninth aspect of the invention, in accordance with one or more embodiments of the present invention, the torque receiving member can be connected to the vehicle body at a position disposed radially outwardly of an outer peripheral edge of the rotor.

As a tenth aspect of the invention, in accordance with one or more embodiments of the present invention, the torque receiving member comprises an interconnecting member interconnecting two members disposed respectively at the inner and outer sides of the rotor, and an anchor member which is disposed closer to the pads than the interconnecting member is, and receives the torque (acting in the direction of rotation of the rotor) from the pads.

As an eleventh aspect of the invention, in accordance with one or more embodiments of the present invention, the anchor member is disposed at a position disposed radially outwardly of the outer peripheral edge of the rotor, and opposite end portions of the anchor member project beyond the interconnecting member respectively toward the two members which are connected to the interconnecting member respectively at the inner and outer sides of the rotor.

As a twelfth aspect of the invention, in accordance with one or more embodiments of the present invention, a floating caliper type disc brake is provided with: a support member which is fixed to a vehicle body, and is disposed adjacent to a rotor rotatable with a wheel; a pair of pads disposed respectively on opposite sides of the rotor; a caliper which is supported on the support member and the pads by guide portions, formed at the support member and the pads, and a guide member, fitted in the guide portions of the pads, in such a manner that the caliper can be displaced in an axial direction of the rotor; a claw portion provided at that portion of the caliper disposed at one side of a bridge portion of the caliper straddling the rotor; and a piston fitted in that portion of the caliper disposed at the other side of the bridge portion. When the piston is pushed out, the pair of pads are pressed respectively against the opposite sides of the rotor, thereby effecting a braking operation. In the floating caliper type disc brake, the support member can be connected to the vehicle body at a position disposed radially outwardly of an outer peripheral edge of the rotor.

As a thirteenth aspect of the invention, the floating caliper type disc brake according to any one of first to twelfth aspects is provided with a resilient member by which opposite end portions of each of the pads are resiliently pressed against the support member in a direction away from an axis of rotation of the rotor.

As a fourteenth aspect of the invention, in the floating caliper type disc brake according to any one of first to thirteenth aspects, the caliper is supported on the pads by at least two guide portions, formed respectively at the pads, and a guide member, fitted in the guide portions, in such a manner that the caliper can be displaced in the axial direction of the rotor; and the pads can slide relative to the support member in the axial direction of the rotor while the displacement of the pads in a radial direction of the rotor is limited.

The floating caliper type disc brake of the first aspect of the invention is provided with a support member, a pair of pads, a caliper, a claw portion, and a piston.

The support member is fixed to a vehicle body, and is disposed adjacent to a rotor rotatable with a wheel.

The pair of pads are disposed respectively on opposite sides of the rotor.

The caliper is supported on the support member so as to be displaced in an axial direction of the rotor.

The claw portion is provided at that portion of the caliper disposed at one side of abridge portion of the caliper straddling the rotor, and the piston is fitted in that portion of the caliper disposed at the other side of the bridge portion.

When the piston is pushed out, the pair of pads are pressed respectively against the opposite sides of the rotor, thereby effecting a braking operation.

In the floating caliper type disc brake of the first aspect of the invention, the support member comprises at least an inner-side mounting member disposed inwardly of the inner side of the rotor in the axial direction of the rotor, and at least one member separate from the inner-side mounting member. The inner-side mounting member and the separate member are connected together at a position disposed radially outwardly of an outer peripheral edge of the rotor.

The floating caliper type disc brake, in the third, seventh, eighth and twelfth aspects of the invention, comprises a support member, a pair of pads, a caliper, a claw portion, and a piston.

The support member is fixed to a vehicle body, and is disposed adjacent to a rotor rotatable with a wheel.

The pair of pads are disposed respectively on opposite sides of the rotor.

The caliper is supported on the support member and the pads by guide portions, formed at the support member and the pads, and a guide member, fitted in the guide portions of the pads, in such a manner that the caliper can be displaced in an axial direction of the rotor.

The claw portion is provided at that portion of the caliper disposed at one side of a bridge portion of the caliper straddling the rotor, and a piston fitted in that portion of the caliper disposed at the other side of the bridge portion.

When the piston is pushed out, the pair of pads are pressed respectively against the opposite sides of the rotor, thereby effecting a braking operation.

In the floating caliper type disc brake of the third aspect of the invention, the support member comprises a torque receiving member which receives a torque (acting in a direction of rotation of the rotor) from the pads during the braking operation at a position disposed radially outwardly of an outer peripheral edge of the rotor, and an outer-side reinforcing member disposed outwardly of the outer side of the rotor in the axial direction of the rotor.

In the floating caliper type disc brake of the seventh aspect of the invention, the support member comprises at least an inner-side mounting member disposed inwardly of the inner side of the rotor in the axial direction of the rotor, and a torque receiving member which receives a torque (acting in a direction of rotation of the rotor) from the pads during the braking operation, and the inner-side mounting member and the torque receiving member are connected together by fixing means (such as welding) or fastening means (such as bolts).

In the floating caliper type disc brake of the eighth aspect of the invention, the support member comprises at least an outer-side reinforcing member disposed outwardly of the outer side of the rotor in the axial direction of the rotor, and a torque receiving member which receives a torque (acting in a direction of rotation of the rotor) from the pads during the braking operation. The outer-side reinforcing member and the torque receiving member are connected together by fixing means (such as welding) or fastening means (such as bolts).

In the floating caliper type disc brake of the twelfth aspect of the invention, the support member can be connected to the vehicle body at a position disposed radially outwardly of an outer peripheral edge of the rotor.

In the floating caliper type disc brakes of any aspects of the invention, the support member is formed by the members which have simple shapes, respectively, and besides an operation for machining the support member can be carried out easily. Therefore, the overall cost of the disc brake can be reduced.

For example, in the floating caliper type disc brake of the first or seventh aspect of the invention, the support member comprises the inner-side mounting member, and the separate member such as the torque receiving member. Therefore, when those portions for receiving a torque (acting in the direction of rotation of the rotor 1) from the outer pad are formed at the separate member, the inner-side mounting member can be formed into a flat plate-like simple shape (that is, the shape does not change in the axial direction of the rotor). The separate member can also be formed into a simple shape, and an operation for machining those portions of the separate member which are to be connected to the inner-side mounting member, as well as an operation for machining the torque receiving portions of the separate member for receiving a torque (acting in the direction of rotation of the rotor 1) from the pads, can be easily carried out. As a result, the overall cost of the disc brake can be reduced. When there are prepared a plurality of kinds of inner-side mounting members which are different in the position of a mounting portion for mounting on the vehicle, a plurality of kinds of disc brakes (which can be mounted respectively on a plurality of kinds of cars which are different in the position of mounting of the support member on the vehicle body) can be obtained (that is, serialized brake models can be provided) while using the separate member as a common part. In this case, the overall cost of the disc brake can be further reduced. Also the degree of freedom of design for the inner-side mounting member can be easily enhanced.

In the floating caliper type disc brake of third or eighth aspect of the invention, the support member comprises the torque receiving member which receives a torque (acting in the direction of rotation of the rotor) from the pads during the braking operation, and the outer-side reinforcing member. Therefore, when those portions for receiving a torque (acting in the direction of rotation of the rotor) from the inner pad are formed at the torque receiving member, the outer-side reinforcing member can be formed into a simple shape. The torque receiving member can also be formed into a simple shape, and an operation for machining those portions of the torque receiving member which are to be connected to the outer-side reinforcing member, as well as an operation for machining the torque receiving portions of the torque receiving member for receiving a torque (acting in the direction of rotation of the rotor 1) from the pads, can be easily carried out. As a result, the overall cost of the disc brake can be reduced. When there are prepared a plurality of kinds of torque receiving members which are different in the thickness in the axial direction of the rotor, a plurality of kinds of disc brakes (which can be mounted respectively on a plurality of kinds of cars having respective rotors of different thicknesses) can be obtained (that is, serialized brake models can be provided) while using the outer-side reinforcing member as a common part. In this case, the overall cost of the disc brake can be further reduced.

In the floating caliper type disc brake of twelfth aspect of the invention, the support member can be connected to the vehicle body at the position disposed radially outwardly of the outer peripheral edge of the rotor. Therefore, the support member does not need to be formed into such a shape as to straddle the outer peripheral portion of the rotor, and the support member can be formed into a simple shape. Therefore, the overall cost of the disc brake can be reduced.

In the floating caliper type disc brake of the first aspect of the invention, preferably, the inner-side member is formed by a plate material having a uniform thickness as the second aspect.

In this construction, the production cost of the inner-side mounting member can be further reduced easily. In this case, also, when the position of the mounting portion (such as mounting holes) of the inner-side mounting member for mounting on the vehicle body is varied, a plurality of kinds of disc brakes (which can be mounted respectively on a plurality of kinds of cars which are different in the position of mounting of the support member on the vehicle body) can be obtained while using the separate member as a common part.

In the construction of the third aspect of the invention, preferably, the torque receiving member and the outer-side reinforcing member are connected together at a position disposed radially outwardly of the outer peripheral edge of the rotor as the forth aspect of the invention.

Preferably, the outer-side reinforcing member is formed by a plate material having a uniform thickness as the fifth aspect of the invention.

In this construction, the production cost of the outer-side reinforcing member can be further reduced easily. In the case where the outer-side reinforcing member is formed by the plate material, with part of this plate material bent, there can be obtained the inexpensive and lightweight construction, and a gap can be secured between the support member and its surrounding parts, and besides the strength of the support member can be increased.

In the construction of third, forth, fifth or eighth aspect of the invention, preferably, the torque receiving member can be connected to the vehicle body at a position disposed radially outwardly of the outer peripheral edge of said rotor, as the sixth or ninth aspect of the invention.

In this construction, the inner-side end portion of the torque receiving member does not need to be bent to be directed inwardly in the radial direction of the rotor at a position disposed inwardly of the inner side of the rotor. Therefore, the torque receiving member can be easily formed into a simpler shape, and the cost can be reduced more easily.

In the construction of seventh or ninth aspect of the invention, preferably, the torque receiving member comprises an interconnecting member interconnecting two members disposed respectively at the inner and outer sides of the rotor, and an anchor member which is disposed closer to the pads than the interconnecting member is, and receives a torque (acting in the direction of rotation of the rotor) from the pads, as the tenth aspect of the invention.

In this construction, the torque receiving member can be produced at a low cost.

Preferably, the anchor member is disposed at a position disposed radially outwardly of the outer peripheral edge of the rotor, and opposite end portions of the anchor member project beyond the interconnecting member respectively toward the two members which are connected to the interconnecting member respectively at the inner and outer sides of the rotor, as the eleventh aspect.

In this construction, even when the two members are formed by plate materials having respective thicknesses smaller than a predetermined value, the axial length of the anchor member can be increased. Therefore, for example, even when new pads, each having a linings of an increased thickness, are used, the pads can be sufficiently engaged with the anchor member, and the shaking of the pads can be suppressed.

In the construction of any one of first to twelfth aspects of the invention, preferably, there is provided a resilient member by which opposite end portions of each of the pads are resiliently pressed against the support member in a direction away from an axis of rotation of the rotor, as the thirteenth aspect.

In this construction, a side surface of each of the opposite end portions of each pad, facing away from its side surface pressed against the support member, can be easily opposed to a side surface of the support member with a gap formed therebetween. Therefore, the pads are effectively prevented from adhering to the support member by rust, and besides even when the resilient member is disengaged out of position, or when the opposite end portions of each pad cease to be pressed respectively against the support member, each pad is prevented from being displaced radially of the rotor in an amount larger than a predetermined value.

In the construction of any one of the first to thirteenth aspects, preferably, the caliper is supported on the pads by at least two guide portions, formed respectively at the pads, and a guide member, fitted in the guide portions, in such a manner that the caliper can be displaced in the axial direction of the rotor, and the pads can slide relative to the support member in the axial direction of the rotor while the displacement of the pads in a radial direction of the rotor is limited, as the fourteenth aspect of the invention.

In this construction, any guide hole for the sliding movement of a guide pin therein does not need to be formed in the support member, and therefore the behavior of the caliper can be suitably controlled during the braking operation, and uneven wear of each pad can be suppressed.

Thus, any guide hole for the sliding movement of a guide pin therein does not need to be formed in the support member, and therefore in the case where only a single guide hole is formed in each of the pads, and only the single guide pin for supporting the caliper is used, the sum of areas of sliding contact portions of the guide pin and areas of sliding contact portions of the guide holes (disposed in sliding contact respectively with the sliding contact portions of the guide pin) can be reduced, and time and labor, required for a cumbersome operation for forming or machining these sliding contact portions, can be reduced as compared with the conventional structure shown in FIGS. 21 and 22. And besides, the number of guide pins and the number of lock pins for connecting the guide pins to the caliper can be reduced, or the use of them can be eliminated. Therefore, the overall production cost of the disc brake can be easily reduced. And besides, the sum of the areas of the sliding contact portions can be reduced, and therefore the precision of displacement of the caliper 2a is less affected by the precision of the shapes of the guide pin and guide holes. Therefore, in the braking operation, the caliper can be easily precisely displaced into a desired condition.

Rust is less liable to develop on the inner peripheral surfaces of the guide holes, and therefore problems, resulting from the development of rust on the sliding contact portions of the guide holes and guide pin (such as an increased sliding resistance and the adhesion of the sliding contact portions to each other), are less liable to arise. And besides, members, such as clips made of a corrosion-resistant material, can be easily provided between the pads and the support member, and problems, resulting from the development of rust, are less liable to be encountered with the sliding contact portions between the pads and the support member.

Other aspects and advantages of the invention will be apparent from the following description and the appended claims.

### BRIEF DESCRIPTION OF THE DRAWINGS

FIG. 1 is a perspective view showing a first embodiment of the present invention.

FIG. 2 is a view of the first embodiment as seen from a radially-outward side of a rotor.

FIG. 3 is a view as seen from a lower side of FIG. 2, with an inner-side mounting member omitted.

FIG. 4 is a view as seen from a right side of FIG. 3.

FIG. 5 is a view as seen from a left side of FIG. 3.

FIG. 6 is a cross-sectional view taken along the line A-A of FIG. 3.

FIG. 7 is a cross-sectional view taken along the line B-B of FIG. 4.

FIG. 8 is an exploded perspective view of a support member.

FIG. 9 is an exploded perspective view of a floating caliper type disc brake, with the inner-side mounting member of the support member omitted.

FIG. 10 is a perspective view showing a condition in which a second embodiment of a floating caliper type disc brake of the invention is to be mounted on a vehicle body.

FIG. 11 is a perspective view of a third embodiment of the invention.

FIG. 12 is a view of the third embodiment as seen from a radially-outward side of a rotor.

FIG. 13 is a view as seen from a lower side of FIG. 12.

FIG. 14 is a view as seen from a right side of FIG. 13.

FIG. 15 is a view as seen from a left side of FIG. 13.

FIG. 16 is a cross-sectional view taken along the line C-C of FIG. 13.

FIG. 17 is a cross-sectional view taken along the line D-D of FIG. 14.

FIG. 18 is an exploded perspective view of a support member.

FIG. 19 is a perspective view showing a condition in which a pair of pads are to be mounted on the support member.

FIG. 20 is a perspective view showing a condition in which the pair of pads, a hold spring and a caliper are mounted on the support member.

FIG. 21 is a view of one conventional structure as seen from a radially-outward side of a rotor.

FIG. 22 is a side-elevational view of the structure of FIG. 21.

### REFERENCE NUMERALS

1 rotor
2, 2a caliper
3, 3a, 3b, 3c support member
4 mounting hole
5 guide pin
6 guide hole
7 boot
8 run-in side engagement portion
9 run-out side engagement portion
10a, 10b pad
11 back plate
12 cylinder portion
13 claw portion
14 piston
15 lining
16 bolt
17 inner-side mounting member
18 torque receiving member
19 run-in side arm portion
20 run-out side arm portion
21 bolt
22 through hole
23 run-in side engagement portion
24 run-out side engagement portion
25 outer-side reinforcing member
26 curved portion
27 leg portion
28 arm portion
29 connection projecting portion
30 engagement projecting portion
31 screw hole
32 step portion
33 engagement convex portion
34 channel-shaped groove
35 step portion
36 channel-shaped groove
37 pad clip
38 guide pin
39 projecting portion
40 guide hole
41 through hole
42 through hole
43 recess-like hole
44 retaining clip
45a, 45b leg portion
46 interconnecting portion
47 bent portion
48 through hole
49 hold spring
50 pressing piece portion
51 interconnecting portion
52 entry portion
53 pressing portion
54 bridge portion
55 knuckle
56 plate portion
57 through hole
58 torque receiving member
59 outer-side reinforcing member
60 anchor member
61 interconnecting member
62 run-in side arm portion
63 run-out side arm portion
64 reinforcing portion
65 through hole
66 step portion
67 screw hole
68 through hole
69 cylinder hole
70 seal ring
72 retaining portion
73 through hole

### DESCRIPTION OF THE PREFERRED EMBODIMENTS

Embodiments of the invention will be described with reference to the accompanying drawings.

### First Embodiment

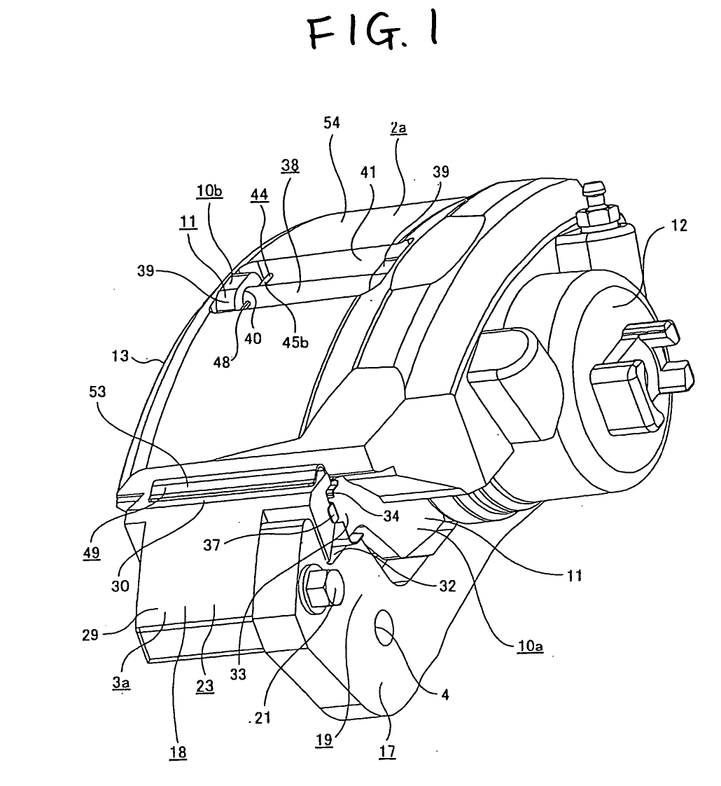

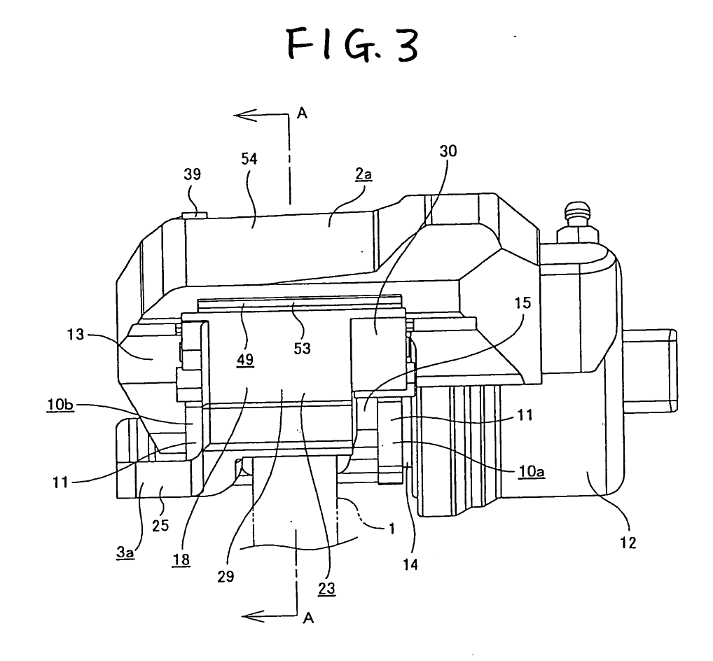

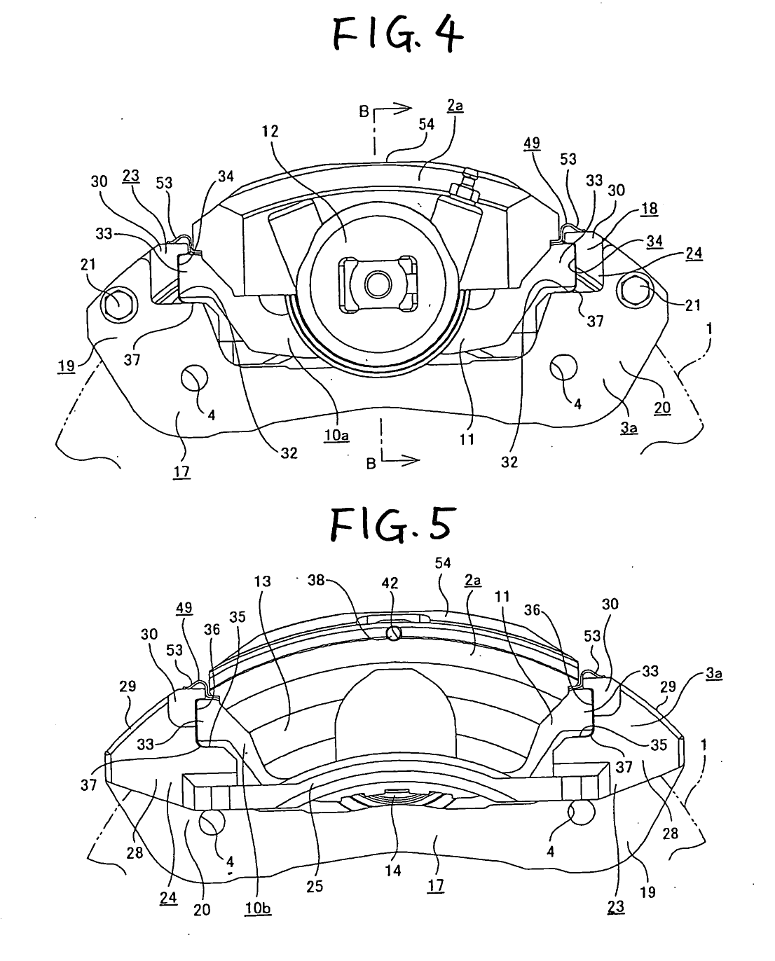

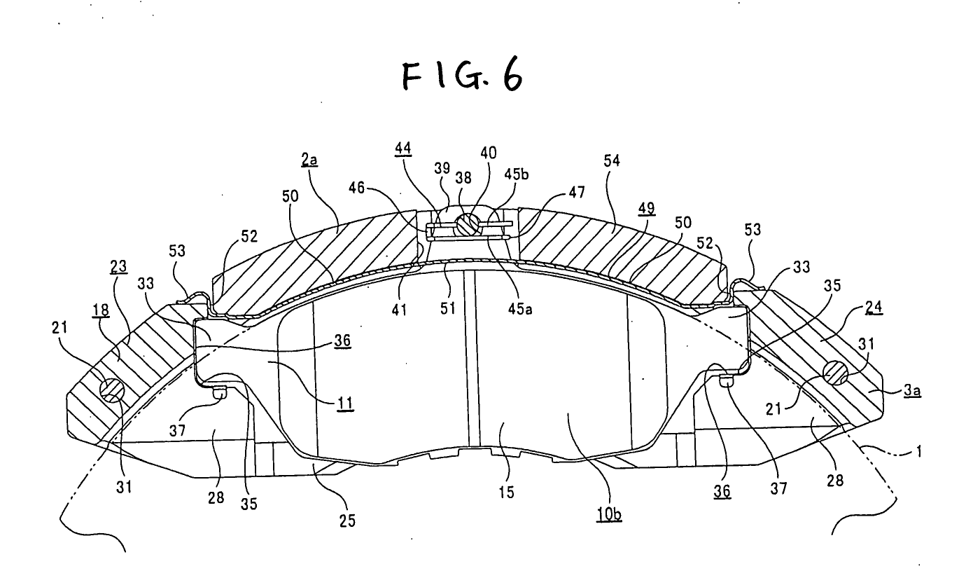

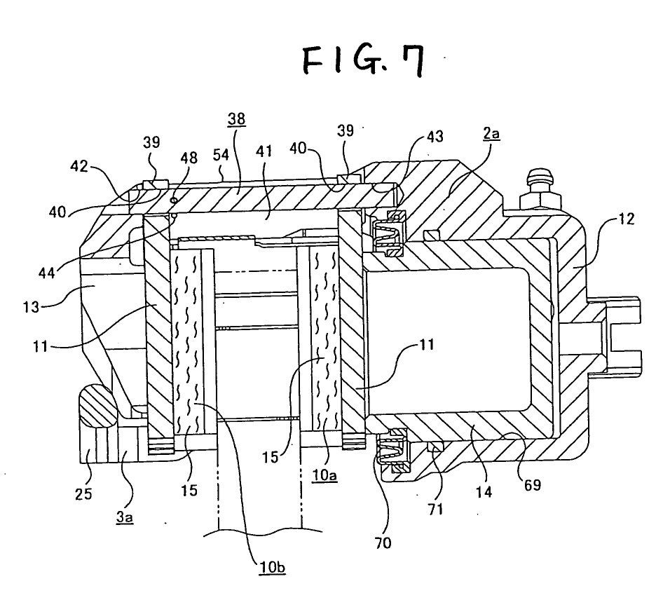

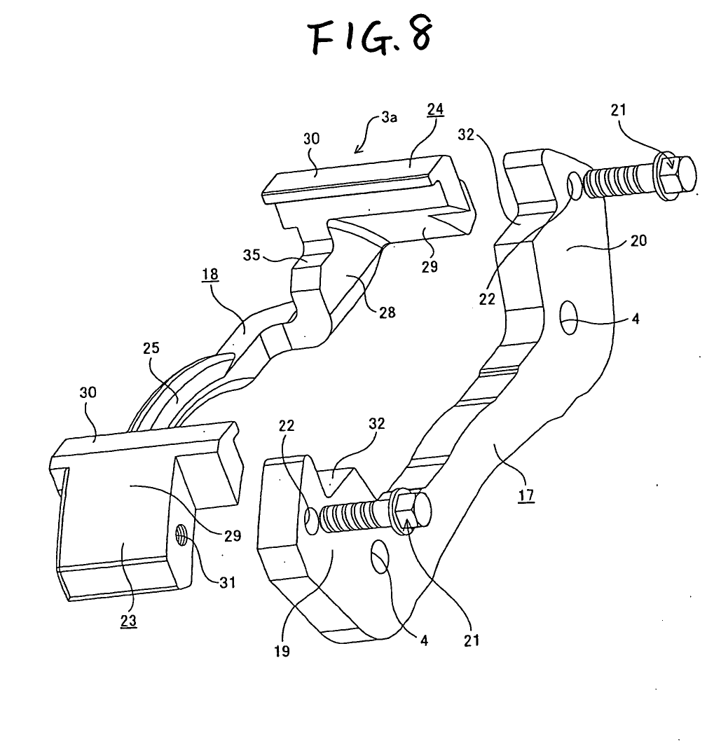

FIGS. 1 to 9 show a first embodiment of the present invention. A floating caliper type disc brake of this embodiment comprises a support member 3a, a pair of pads 10a and 10b, a caliper 2a, a claw portion 13, and a piston 14. The claw portion 13 is provided at an outer side of a bridge portion 54 of the caliper 2a straddling a rotor 1. The piston 14 is fitted liquid-tight in a cylinder hole 69 formed in a cylinder portion 12 formed at an inner side of the bridge portion 54. A piston boot 70, made of an elastic material, is provided between an inner peripheral surface of an open end portion of the cylinder hole 9 and an outer peripheral surface of a distal end portion of the piston 14. A seal ring 71, made of an elastic material, is provided between an inner peripheral surface of an intermediate portion of the cylinder hole 69 and an outer peripheral surface of an intermediate portion of the piston 14.

Particularly in this embodiment, the support member 3a comprises an inner-side mounting member 17 disposed inwardly of the inner side of the rotor 1 in the axial direction of the rotor 1, and a torque receiving member 18 which is separate from the inner-side mounting member 17, as shown in detail in FIG. 8. The inner-side mounting member 17 is composed of a generally U-shaped flat plate formed by a metal plate of a uniform thickness such as a hot-rolled steel plate. A pair of mounting holes 4 and 4 are formed through a lower portion of the inner-side mounting member 17 in a direction parallel to the axis of the rotor 1. The inner-side mounting member 17 has a pair of run-in side and run-out side arm portions 19 and 20 formed respectively at its opposite ends spaced from each other in a direction of rotation of the rotor 1. A pair of through holes 22 and 22 are formed respectively through distal end portions of the run-in side and run-out side arm portions 19 and 20 in a direction parallel to the axis of the rotor 1. The through holes 22 are disposed radially outwardly of an outer peripheral edge of the rotor 1.

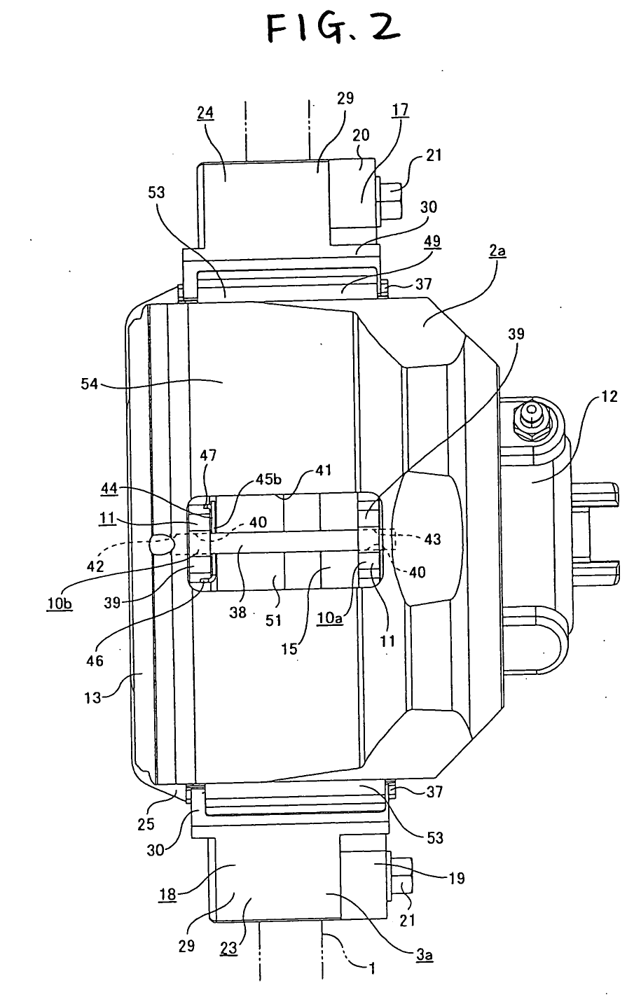

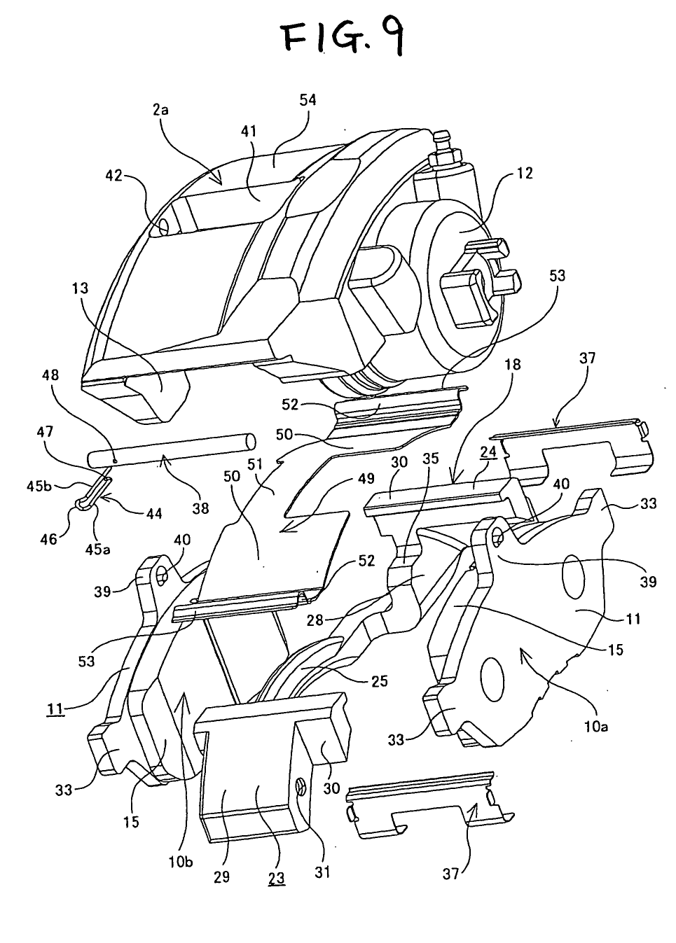

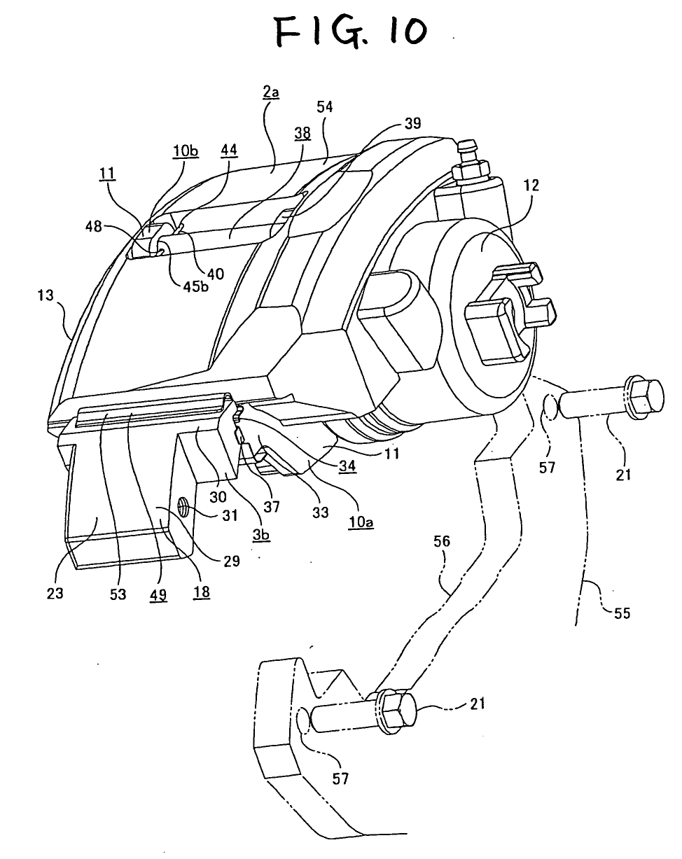

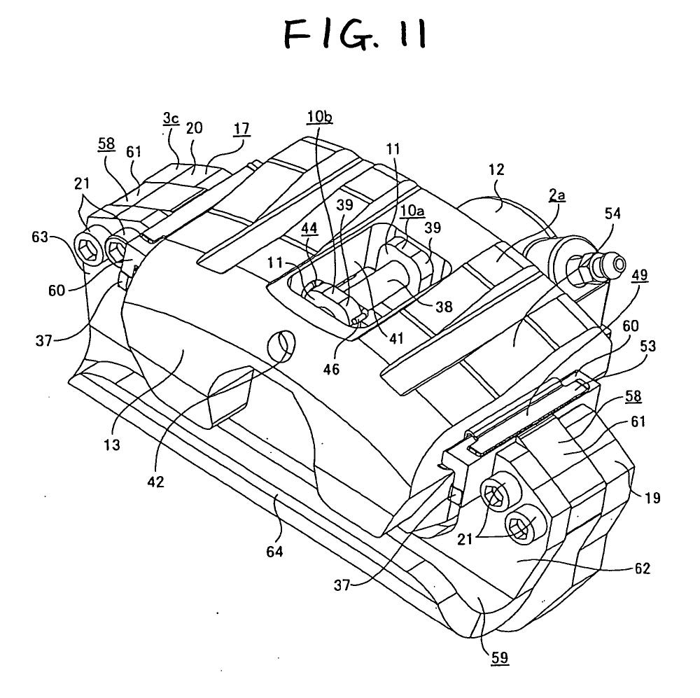

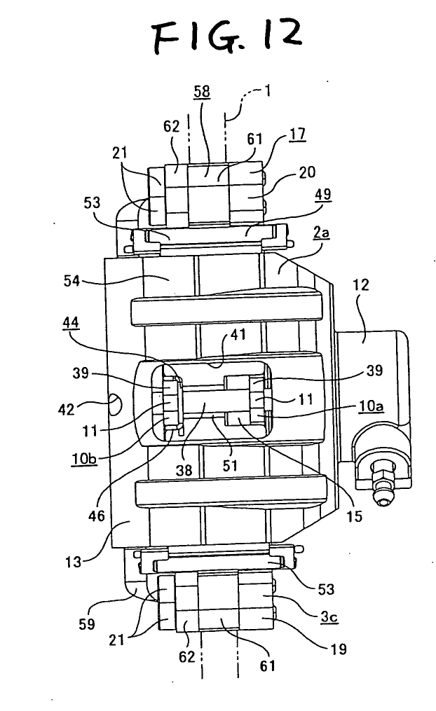

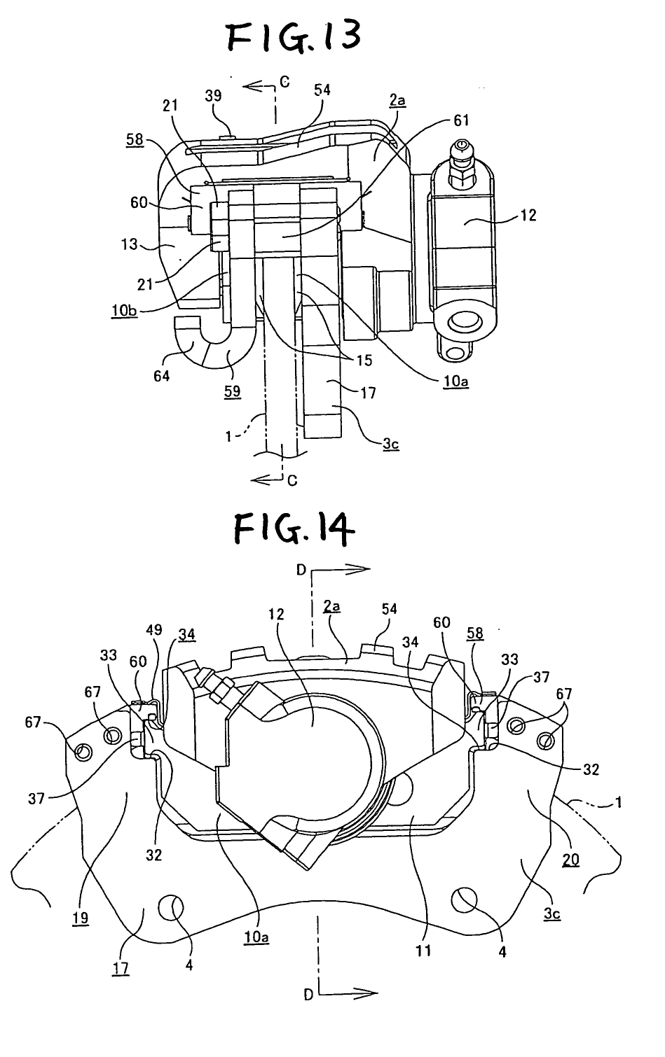

The torque receiving member 18 is made of metal such as steel, and includes run-in side and run-out side engagement portions 23 and 24 formed respectively at its opposite ends spaced from each other in the direction of rotation of the rotor 1, and an outer-side reinforcing portion 25 interconnecting lower ends of the run-in side and run-out side engagement portions 23 and 24. The run-in side and run-out side engagement portions 23 and 24 include respective arm portions 28 and 28 connected respectively to opposite ends of the outer-side reinforcing portion 25, and extending outwardly in the radial direction of the rotor 1, respective connection projecting portions 29 and 29 of a generally arc-shaped cross-section formed respectively at radially-outward end edges of the arm portions 28 and 28, and respective engagement projecting portions 30 and 30 of an L-shaped cross-section formed respectively at the radially-outward end edges of the arm portions 28 and 28. As compared with the connection projecting portions 29 and 29, the engagement projecting portions 30 and 30 are disposed closer to a central portion of the torque receiving member 18 in a direction of a width thereof (in a front-rear direction in FIGS. 1, 3 and 7 to 9; in an upward-downward direction in FIG. 2; in a left-right direction in FIGS. 4 to 6), and are opposed to each other in a circumferential direction of the rotor 1. Inner side surfaces (right side surfaces in FIG. 8) of the connection projecting portions 29 and 29 are disposed in an imaginary common plane parallel to a plane of the rotor 1. Further, the inner side surfaces of these connection projecting portions 29 and 29 can abut respectively against outer side surfaces (left side surfaces in FIG. 8) of the run-in side and run-out side arm portions 19 and 20 formed at the inner-side mounting member 17. Screw holes 31 are formed respectively in the inner side surfaces of the connection projecting portions 29 and 29, and can be aligned respectively with the through holes 22 and 22 formed respectively through the arm portions 19 and 20 of the inner-side mounting member 17, axes of the screw holes 31 being parallel to the axis of the rotor 1.

The through holes 22 and 22, formed respectively through the engagement arm portions 19 and 20 of the inner-side mounting member 17 are aligned with the screw holes 31, respectively, and in this condition bolts 21 and 21 are passed respectively through the through holes 22 and 22, and are threaded at their externally-threaded portions into the screw holes 31, and are tightened. With this construction, the torque receiving member 18 and the inner-side mounting member 17 are coupled or connected together at a position disposed radially outwardly of the outer peripheral edge of the rotor 1. In this condition, those portions of the engagement projecting portions 30 and 30 (of the torque receiving member 18), projecting inwardly respectively from the connection projecting portions 29 and 29, are received respectively in step portions 32 and 32 of an L-shaped cross-section which are formed respectively on inner surfaces (close to the central portion of the inner-side mounting member 17 in the direction of the width thereof) of the run-in side and run-out side arm portions 19 and 20 at upper end portions thereof. Inner surfaces of the portions of the engagement projecting portions 30 and 30, projecting inwardly respectively from the connection projecting portions 29 and 29, cooperate respectively with upper surfaces of the step portions 32 and 32 to form a pair of channel-shaped grooves 34 and 34 (FIGS. 1 and 4) of a channel-shaped (or generally U-shaped) cross-section. Engagement convex portions 33 and 33 (FIG. 1 and others), formed respectively at opposite ends of a back plate 11 of the inner pad 10a, can be engaged in the channel-shaped grooves 34 and 34, respectively. Inner surfaces of outer-side portions of the engagement projecting portions 30 and 30 of the torque receiving member 18 cooperate respectively with inner surfaces of step portions 35 and 35 (which are formed respectively on inner surfaces (close to the central portion of the torque receiving member 18 in the direction of the width thereof) of the arm portions 28 and 28 at upper end portions thereof) to form a pair of channel-shaped grooves 36 and 36 (FIG. 6). Engagement convex portions 33 and 33, formed respectively at opposite ends of a back plate 11 of the outer pad 10b, can be engaged in the channel-shaped grooves 36 and 36, respectively.

A pair of pad clips 37 and 37 are mounted on the engagement projecting portions 30 and 30 of the torque receiving member 18 and the run-in side and run-out side arm portions 19 and 20 of the inner-side mounting member 17 in such a manner that each pad clip 37 covers the inner surfaces of the corresponding channel-shaped grooves 34 and 36 and that portion of the torque receiving member 18 lying between these channel-shaped grooves 34 and 36. Each pad clip 37 is formed into an integral construction, using a metal sheet (such as a stainless steel sheet) having corrosion resistance and resiliency. The pad clips 37 and 37 serve to prevent the pads 10a and 10b from shaking relative to the support member 3a in an inoperative condition of the disc brake. The pad clips 37 and 37 also have the function of preventing those portions of the back plates 11 and 11 (of the pads 10a and 10b) and support member 3a, disposed in sliding contact with each other, from being rusted. The engagement convex portions 33, formed respectively at the opposite ends (spaced from each other in the circumferential direction of the rotor 1) of the back plate 11 of the pad 10a are engaged respectively in the channel-shaped grooves 34 via the pad clips 37 and 37 so as to slide in the axial direction of the rotor 1. Similarly, the engagement convex portions 33, formed respectively at the opposite ends (spaced from each other in the circumferential direction of the rotor 1) of the back plate 11 of the pad 10b are engaged respectively in the channel-shaped grooves 36 via the pad clips 37 and 37 so as to slide in the axial direction of the rotor 1.

The support member 3a of the above construction is fixedly connected to a knuckle, forming a suspension device (not shown), by bolts (not shown) passing respectively through the mounting holes 4 and 4 formed in the inner-side mounting member 17. As a result, the support member 3a is fixed to a vehicle body in adjoining relation to the rotor 1. In this condition, the support member 3a straddles the outer peripheral portion of the rotor 1 in the left-right direction in FIG. 2.

The caliper 2a is supported by a single guide pin 38 so as to be displaced relative to the pads 10a and 10b in the axial direction of the rotor 1. Therefore, projecting portions 39 and 39 are formed respectively at central portions thereof (in the widthwise direction (that is, in the front-rear direction in FIGS. 1, 3 and 7 to 9; in the upward-downward direction in FIG. 2; in the left-right direction in FIGS. 4 to 6))) of the back plates 11 and 11 of the pads 10a and 10b, and project radially outwardly of the rotor 1. Guide holes 40 and 40 (FIGS. 6 and 9) are formed respectively through the projecting portions 39 and 39 in a direction parallel to the axial direction of the rotor 1. A through hole 41 is formed through a widthwise-central portion of the bridge portion 54 (which interconnects the claw portion 13 and the cylinder portion 12 of the caliper 2) in the radial direction of the rotor 1. A through hole 42 (FIGS. 5, 7 and 9) is formed through the claw portion 13 in the axial direction of the rotor 1, and a recess-like hole 43 (FIG. 7) with a closed bottom is formed in the cylinder portion 12. The through hole 42 and the recess-like hole 43 are coaxial with each other, and the through hole 41 lies between the through hole 42 and the recess-like hole 43. Opposite end portions of the single metal guide pin 38 are inserted in the through hole 42 and the recess-like hole 43, respectively, and also two portions of this guide pin 38, spaced from each other in a direction of a length thereof, are passed through the guide holes 40 and 40 (formed respectively through the pads 10a and 10b) so as to slide in the axial direction of the rotor 1.

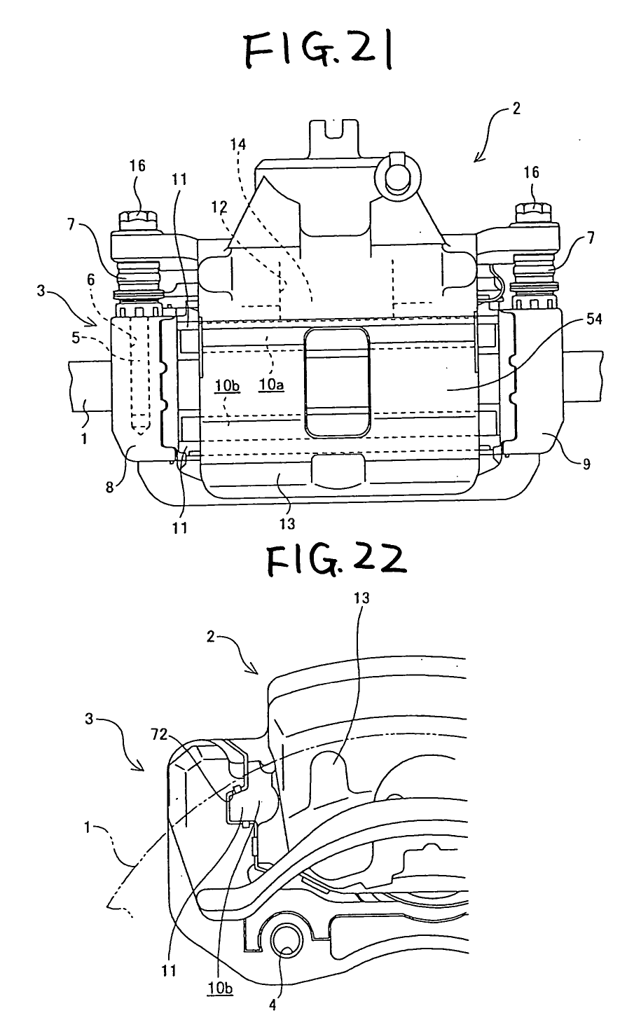

A retaining clip 44 is retainingly mounted on that portion of the guide pin 38 which is intermediate opposite ends thereof, and is disposed between the projecting portions 39 and 39 of the pads 10a and 10b. As shown in detail in FIGS. 6 and 9, this retaining clip 44 includes a pair of parallel leg portions 45a and 45b, and an interconnecting portion 46 of a U-shape interconnecting one ends of the two leg portions 45a and 45b, the interconnecting portion 46 being bent generally at a right angle relative to the leg portions 45a and 45b. A distal end portion of one leg portion 45a is bent in the same direction as the interconnecting portion 46 to provide a bent portion 47. The other leg portion of the retaining clip 44 is passed through a through hole 48 (which is formed through the guide pin 38 in a diametrical direction thereof intermediate the opposite ends thereof), so that the one leg portion 45a is resiliently pressed against the outer peripheral surface of the guide pin 38. The interconnecting portion 46 of the retaining clip 44 and the bent portion 47 (formed at the one leg portion 45a) are engaged respectively with side edges of the projecting portion 39 of the back plate 11 of the outer pad 10b. With this condition, the positioning of the retaining clip 44 is effected. The guide pin 38 is prevented by the retaining clip 44 from being disengaged or separated from the caliper 2a. Namely, the displacement of the guide pin 38 relative to the caliper 2a in the inward (inner-side) direction (in the right direction in FIGS. 1 to 3 and 7 to 9; in the front-side direction in FIGS. 4 and 6; in the reverse-side direction in FIG. 5) is prevented by abutting engagement of the inner end of the guide pin 38 with the bottom of the recess-like hole 43 formed in the caliper 2a. On the other hand, the displacement of the guide pin 38 relative to the caliper 2a in the outward (outer-side) direction (in the left direction in FIGS. 1 to 3 and 7 to 9; in the reverse-side direction in FIGS. 4 and 6; in the front-side direction in FIG. 5) is prevented by engagement of the retaining clip 44 with the projecting portion 39 of the back plate 11 of the outer pad 10b. Thus, thanks to the provision of the retaining clip 44, the guide pin 38 can not be disengaged or separated from the caliper 2a. In this embodiment, the caliper 2a is supported on the guide pin 38, and therefore it is not necessary to connect a lock pin 16 (see FIG. 21) to the guide pin 38, and the guide pin 38 has a simple shape.

In this embodiment, the guide pin 38, supported on the caliper 2a, is passed through the guide holes 40 and 40 (formed respectively through the pads 10a and 10b) so as to slide in the axial direction as described above, and therefore the caliper 2a is supported so as to be displaced relative to the pads 10a and 10b in the axial direction of the rotor 1.

In this embodiment, a hold spring 49 (which is a resilient member) is provided between the outer peripheral edges of the back plates 11 and 11 of the pads 10a and 10b and an inner surface of the caliper 2a opposed to the back plates 11 and 11 and the outer peripheral edge of the rotor 1 in the radial direction of the rotor 1. The hold spring 49 imparts a resilient force to the caliper 2a to urge the same in a direction away from the center (axis) of the rotor 1. Namely, the hold spring 49 is formed into a shape shown in detail in FIGS. 6 and 9, using a metal sheet having relatively high rigidity. This hold spring 49 includes a pair of pressing piece portions 50 and 50 formed respectively at opposite ends thereof (spaced from each other in the circumferential direction of the rotor 1), and an interconnecting portion 51 of an arcuate cross-section interconnecting opposed end edges of the two pressing piece portions 50 and 50, the interconnecting portion 51 having a reduced width. A generally half portion of each of the pressing piece portions 50 and 50, disposed close to a central portion of the hold spring 49, is formed into an arcuate cross-sectional shape conforming to the shape of the inner surface of the caliper 2a. Entry portions 52 and 52 are formed respectively at the other ends (which define the opposite ends of the hold spring 49, respectively) of the pressing piece portions 50 and 50. One entry portion 52 can intrude between one of the opposite side surfaces (spaced from each other in the direction of the width of the caliper 2a) of the caliper 2a and the inner surface of the run-in side engagement portion 23 of the support member 3a, while the other entry portion 52 can intrude between the other side surface of the caliper 2a and the inner surface of the run-out side engagement portion 24 of the support member 3a. Pressing portions 53 and 53 which can abut respectively against the outer surfaces of the engagement portions 23 and 24 are formed respectively at radially-outwardly (with respect to the rotor 1) projecting portions of the entry portions 52 and 52, and project radially outwardly of the rotor 1. The half portions of the pressing piece portions 50 and 50 are resiliently pressed against the inner surface of the caliper 2a, and the pressing portions 53 and 53 are resiliently pressed against the radially-outward surfaces of the engagement portions 23 and 24, respectively. With this construction, the hold spring 49 imparts a resilient force to the caliper 2a and the pads 10a and 10b (supported on the caliper 2a through the guide pin 38) to urge them in a direction away from the axis of the rotor 1. The entry portions 52 and 52 of the pressing piece portions 50 and 50, as well as the pressing portions 53 and 53, are spaced respectively from the opposite side surfaces (spaced from each other in the direction of the width of the caliper 2a) of the caliper 2a.

As described above, in this embodiment, the resilient force is applied from the holding spring 49 to the caliper 2a and the pads 10a and 10a to urge them away from the axis of the rotor 1. Therefore, the engagement convex portions 33 and 33, formed respectively at the opposite ends of the back plate 11 of the pad 10a, are resiliently pressed respectively against radially-outward surfaces (which are disposed outwardly in the radial direction of the rotor 1) of the inner surfaces of the channel-shaped grooves 34 formed in the support member 3a. Similarly, the engagement convex portions 33 and 33, formed respectively at the opposite ends of the back plate 11 of the pad 10b, are resiliently pressed respectively against radially-outward surfaces of the inner surfaces of the channel-shaped grooves 36 formed in the support member 3a. The rotors 10a and 10b can be slid relative to the support member 3a in the axial direction of the rotor 1 while the displacement of the pads 10a and 10b in the radial direction of the rotor 1 is limited. A gap of about 1 mm exists between a radially-inward surface (which is disposed inwardly in the radial direction of the rotor 1) of the inner surface of each channel-shaped recess 34, 36 and the corresponding engagement convex portion 33 in the radial direction of the rotor 1.

The floating caliper type disc brake of the above construction is assembled in the following manner. First, the inner-side mounting member 17 and the torque receiving member 18 are connected together by the bolts 21 and 21 to form the support member 3a. In this condition, the pad clips 37 and 37 are attached to the support member 3a in such a manner that each pad clip 37 covers the corresponding pair of channel-shaped recesses 34 and 36 in a bridging manner. Then, the pads 10a and 10b are mounted on the support member 3a in such a manner that the engagement convex portions 33 and 33, formed respectively at the opposite ends of each of the back plates 11 and 11 of the pads 10a and 10b, are fitted respectively in the channel-shaped recesses 34, 36. The hold spring 49 is placed close to the radially-outward edges of the pads 10a and 10b in such a manner that the pressing portions 53 and 53, formed respectively at the opposite ends of the hold spring 49, are pressed respectively against the radially-outward surfaces of the run-in side and run-out side engagement portions 23 and 24. Then, the caliper 2a is located in a manner to fit on the pads 10a and 10b in such a manner that the inner surface of the caliper 2a presses the half portions of the pressing piece portions 50 and 50 of the hold spring 49. The guide holes 40 and 40, formed respectively through the back plates 11 and 11 of the pads 10a and 10b, are aligned with the through hole 42 and the recess-like hole 43 which are formed in the caliper 2a. In this condition, the guide pin 38 is passed through the through hole 42 and the guide holes 40, and is inserted into the recess-like hole 43, and then the leg portion 45b of the retaining clip 44 is passed through the through hole 48 in the guide pin 38, thereby retainingly mounting the retaining clip 44 on the guide pin 38. In this condition in which the retaining clip 44 is retainingly mounted on the guide pin 38, the guide pin 38 can not be disengaged from the caliper 2a. In this manner, the above floating caliper type disc brake is assembled.

In the floating caliper type disc brake which has the above construction, and is assembled in the above-mentioned manner, the support member 3a is formed by the inner-side mounting member 17 and the torque receiving member 18 which have the simple shapes, respectively. And besides, an operation for machining the support member 3a can be easily carried out, and therefore the overall cost of the disc brake can be reduced.

Namely, in this embodiment, the support member 3a comprises the inner-side mounting member 17, and the torque receiving member 18 separate from the inner-side mounting member 17. Therefore, when the engagement projecting portions 30 and 30 (which serve as torque receiving portions for receiving a torque (acting in the direction of rotation of the rotor 1) from the pads 10a and 10b during the braking operation) are formed at the torque receiving member 18 as in this embodiment, such torque receiving portions do not need to be formed at the inner-side mounting member 17. Therefore, the inner-side mounting member 17 can be formed into the flat plate-like simple shape (that is, the shape does not change in the axial direction of the rotor 1). In the case where guide holes 6 and 6 (as shown in FIGS. 21 and 22) for the insertion of guide pins 5 and 5 thereinto are not formed in the support member 3a as in this embodiment, the inner-side mounting member 17 can be formed into a simpler shape. Even in the case where the guide holes 6 and 6 (as shown in FIGS. 21 and 22) for the insertion of the guide pins 5 and 5 thereinto are formed in the support member 3a as is not the case with this embodiment, the inner-side mounting member 17 can be formed into the flat plate-like simple shape when the guide holes 6 and 6 are formed in other constituent member of the support member 3a separate from the inner-side mounting member 18.

In this embodiment, the torque receiving member 18 does not need to be directly connected to the knuckle, and therefore this torque receiving member 18 can also be formed into the simple shape. Therefore, an operation for machining those portions of the inner side surface of the torque receiving member 18 which are to be connected to the inner-side mounting member 17, as well as an operation for machining the inner surfaces of the run-in side and run-out side engagement portions 23 and 24 (which serve as torque receiving portions for receiving a torque (acting in the direction of rotation of the rotor 1) from the pads 10a and 10b) of the torque receiving member 18, can be easily carried out. As a result, the overall cost of the disc brake can be reduced. When there are prepared a plurality of kinds of inner-side mounting members 17 which are different in the positions of the mounting holes 4 and 4 (serving as the mounting portion for the knuckle), a plurality of kinds of disc brakes (which can be mounted respectively on a plurality of kinds of cars which are different in the position of mounting of the support member 3a on the knuckle) can be obtained (that is, serialized brake models can be provided) while using the torque receiving member 18, the pad clips 37 and 37 and the bolts 21 and 21 (which are separate from the inner-side mounting member 17) of the support member 3a as common parts. In this case, the overall cost of the disc brake can be further reduced. Also in this case, the degree of freedom of design for the inner-side mounting member 17 can be easily enhanced.

In this embodiment, the inner-side mounting member 17 and the torque receiving member 18 are connected together by the bolts 21 and 21 at the position disposed radially outwardly of the outer peripheral edge of the rotor 1. Therefore, the inner-side mounting member 17 can be connected to the torque receiving member 18 without complicating the shape of the inner-side mounting member 17, and the shape of the inner-side mounting member 17 can be easily made simpler. As a result, the cost can be easily reduced. And besides, the inner-side mounting member 17 is formed of the metal plate having a uniform thickness, and therefore a shaping operation, required for obtaining the inner-side mounting member 17, can be achieved merely by a simple machining operation, and the cost of the inner-side mounting member 17 can be further reduced easily.

In this embodiment, by the hold spring 49, the engagement convex portions 33 and 33, formed respectively at the opposite ends of each of the pads 10a and 10b, are resiliently pressed respectively against the radially-outward surfaces of the inner surfaces of the channel-shaped grooves 34, 36 (of the support member 3a) in the direction away from the axis of rotation of the rotor 1. Therefore, the radially-inward surface (with respect to the radial direction of the rotor 1) of each engagement convex portion 33, facing away from its radially-outward surface pressed against the support member 3a, can be easily opposed to the side surface of the step portion 32, 35 of the support member 3a with a gap formed therebetween. Therefore, the pads 10a and 10b are effectively prevented from adhering to the support member 3a by rust, and besides even when the hold spring 49 is disengaged out of position, or when the engagement convex portions 33 of each of the pads 10a and 10b cease to be pressed respectively against the radially-outward surfaces of the inner surfaces of the channel-shaped grooves 34, 36, each pad 10a, 10b is prevented from being displaced relative to the support member 3a in the radial direction of the rotor 1 in an amount larger than a predetermined value.

In this embodiment, the caliper 2 is supported on the pads 10a and 10b through the guide holes 40 and 40 (formed respectively through the pads 10a and 10b) and the single guide pin 38 (fitted in the guide holes 40 and 40) so as to be displaced in the axial direction of the rotor 1. The pads 10a and 10b can be displaced relative to the support member 3a in the axial direction of the rotor 1 while the displacement of the pads 10a and 10b in the radial direction of the rotor 1 is limited. In this embodiment, guide holes 6 and 6 for the sliding movement of guide pins 5 and 5 therein as shown in FIGS. 21 and 22 do not need to be formed in the support member 3a. Therefore, the behavior of the caliper 2a can be suitably controlled during the braking operation, and uneven wear of each pad 10a, 10b can be suppressed. Namely, in this embodiment, when pressurized oil is fed into the cylinder portion 12 at the time of the braking operation, the piston 14, fitted liquid-tight in the cylinder portion 12, presses the lining 15 of the inner pad 10a against the inner side or face of the rotor 1. At this time, as a reaction of this pressing force, the caliper 2a is displaced inward (toward the inner side), so that the claw portion 13 presses the lining 15 of the outer pad 10b against the outer face of the rotor 1. At this time, the caliper 2a, supported on the guide pin 38, is displaced in the axial direction of the rotor 1 through the sliding movement of the guide pin 38 relative to the guide holes 40 and 40 formed respectively through the pads 10a and 10b.

Thus, in the floating caliper type disc brake of this embodiment, the guide holes 40 and 40 for allowing the sliding movement of the guide pin 38 are formed in the pads 10a and 10b, respectively, and therefore the guide holes 6 and 6 for the sliding movement of the guide pins 5 and 5 therein do not need to be formed in the support member 3a. And besides, the caliper 2a merely receives a reaction force from the rotor 1 via the pads 10a and 10b when the piston 14 is pushed out by the pressurized oil fed into the cylinder portion 12 during the braking operation, and even when the support member 3a is deformed upon reception of braking torques from the pads 10a and 10b, the caliper will not be much inclined relative to the plane of the rotor 1 in contrast with the conventional structure shown in FIGS. 21 and 22. Furthermore, even when the caliper 2a receives a force, acting in the direction of rotation of the rotor 1, from the pads 10a and 10b during the braking operation, a moment, acting on the caliper 2a, can be reduced or eliminated. As a result, uneven wear of the pads 10a and 10b can be suppressed.

The guide holes 6 and 6 for the sliding movement of the guide pins 5 and 5 therein do not need to be formed in the support member 3a, and therefore in the case where only the single guide hole 40 is formed in each of the pads 10a and 10b, and only the single guide pin 38 is supported on the caliper 2a as in this embodiment, the sum of areas of sliding contact portions of the guide pin 38 and areas of sliding contact portions of the guide holes 40 and 40 (disposed in sliding contact respectively with the sliding contact portions of the guide pin 38) can be reduced, and time and labor, required for a cumbersome operation for forming or machining these sliding contact portions, can be reduced as compared with the conventional structure shown in FIGS. 21 and 22. And besides, the number of the guide pin 38 can be reduced to one, and also the use of bolt 16 (see FIG. 21) for connecting the guide pin 38 to the caliper 2a can be omitted. Therefore, the overall production cost of the disc brake can be easily reduced. And besides, the sum of the areas of the sliding contact portions can be reduced, and therefore the precision of displacement of the caliper 2a is less affected by the precision of the shapes of the guide pin 38 and guide holes 40 and 40. Therefore, in the braking operation, the caliper 2a can be easily precisely displaced into a desired condition.

Rust is less liable to develop on the inner peripheral surfaces of the guide holes 40 and 40, and therefore problems, resulting from the development of rust on the sliding contact portions of the guide holes 40 and 40 and guide pin 38 (such as an increased sliding resistance and the adhesion of the sliding contact portions to each other), are less liable to arise. And besides, in this embodiment, the pad clips 37 and 37, made of a corrosion-resistant material, can be easily provided between the pads 10a and 10b and the support member 3a, and problems, resulting from the development of rust, are less liable to be encountered with the sliding contact portions between the pads 10a and 10b and the support member 3a. In the case where the through hole 41, formed in the widthwise-central portion of the caliper 2a, is closed by a transparent synthetic resin-molded cover or the like, the problems, resulting from the development of rust on the sliding contact portions of the guide holes 40 and 40 and guide pin 38, are still less liable to arise.

The inner-side mounting member 17 and the torque receiving member 18 can be fixedly connected together not by the fastening means such as the bolts 21 and 21 (as in this embodiment) but by fixing means (such as welding).

### Second Embodiment

FIG. 10 shows a second embodiment of the invention. This embodiment differs from the first embodiment in that a support member 3b is not provided with the inner-side mounting member 17 (see FIG. 1). Instead, a torque receiving member 18 of the support member 3b can be directly connected to a knuckle 55 at a position disposed radially outwardly of an outer peripheral edge of a rotor 1 (see FIGS. 4 to 6 and others). Therefore, in this embodiment, screw holes 31 are formed respectively through a run-in side engagement portion 23 and a run-out side engagement portion 24 (see FIGS. 8 and 9 and others) of the torque receiving member 18 in a direction parallel to the axis of the rotor 1. A pair of through holes 57 and 57 are formed respectively through two portions of a plate portion 56 of the knuckle 55 which are spaced from each other in a circumferential direction of the rotor 1, axes of the through holes 57 being parallel to the axis of the rotor 1. Bolts 21 and 21 are passed respectively through the through holes 57 and 57, and are threaded at their externally-threaded portions into the screw holes 31, respectively.

In this embodiment, the provision of the inner-side mounting member 17 as used in the first embodiment can be omitted, and therefore the cost can be reduced. And besides, inner-side end portions of the support member 3a do not need to be bent radially inwardly with respect to the rotor 1 at a position disposed inwardly of the inner side of the rotor 1 in an axial direction of the rotor 1. Namely, the support member 3b does not need to be formed into such a shape as to straddle the outer peripheral portion of the rotor 1. Therefore, the support member 3b can be easily formed into a simple shape, and the overall cost of the disc brake can be further reduced.

The other construction and operation are similar to those of the above first embodiment, and therefore identical or similar portions are designated by identical reference numerals, respectively, and explanation thereof is omitted here.

### Third Embodiment

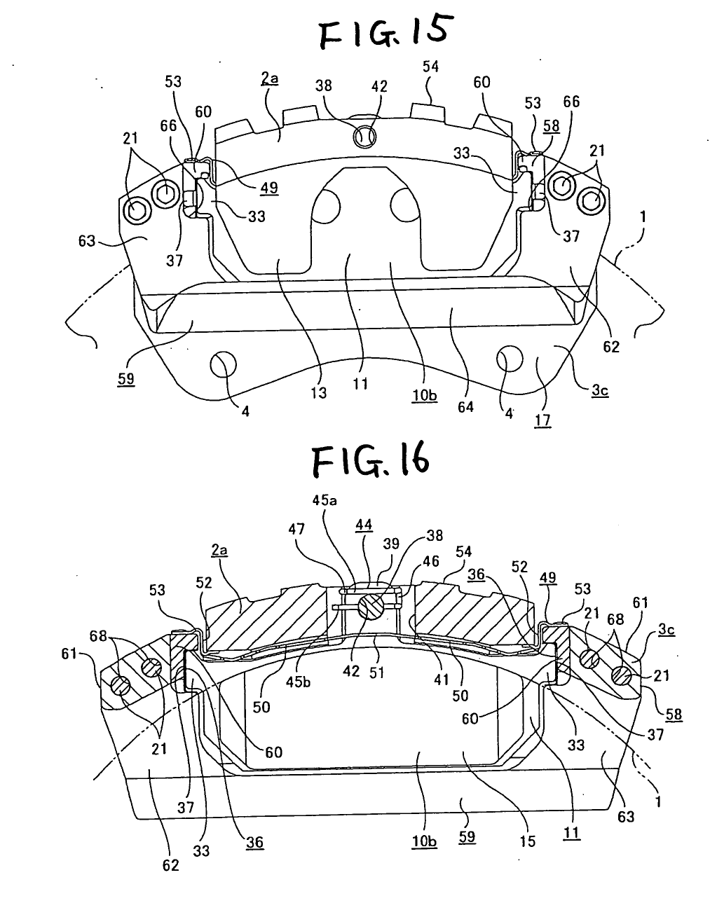

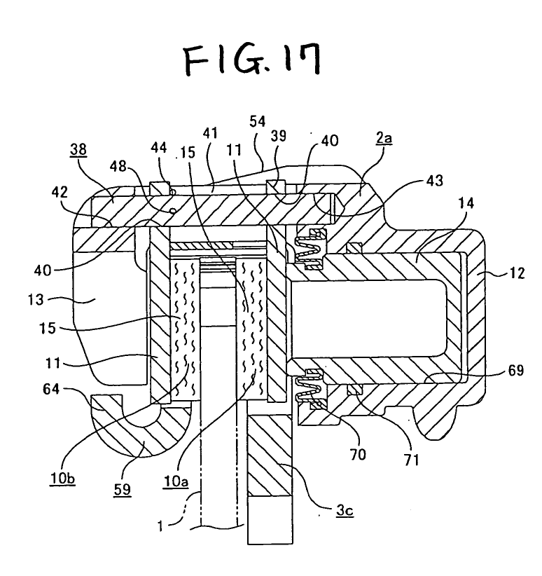

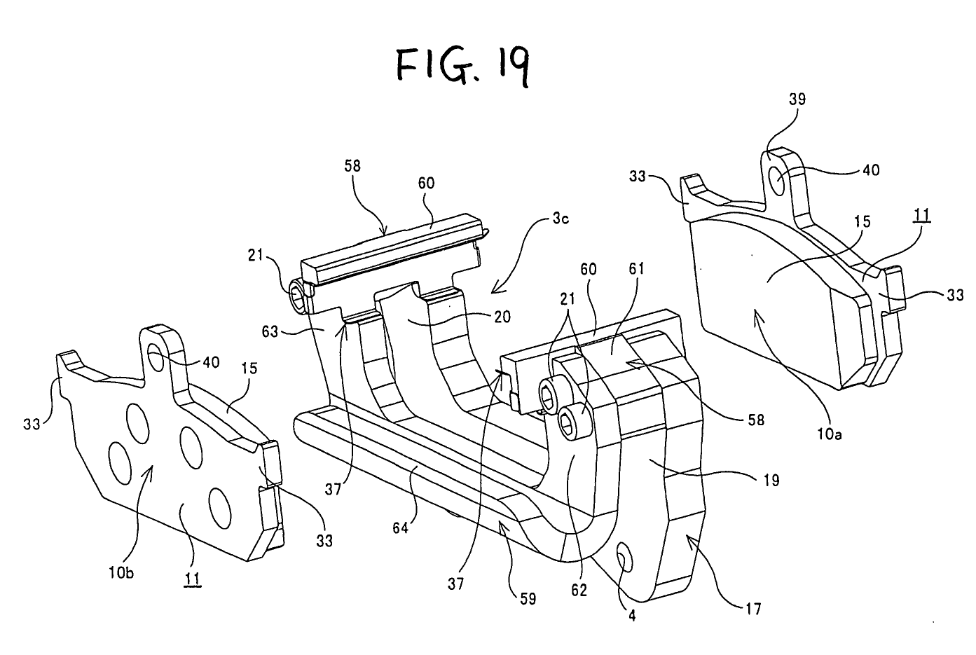

FIGS. 11 to 20 show a third embodiment of the invention. This embodiment differs from the above embodiments in that a support member 3c comprises an inner-side mounting member 17 disposed inwardly of an inner side of a rotor 1 in an axial direction of the rotor 1, a pair of torque receiving members 58 and 58, and an outer-side reinforcing member 59 disposed outwardly of an outer side of the rotor 1 in the axial direction of the rotor 1. In use, the torque receiving members 58 and 58 receives from pads 10a and 10b a torque acting in a direction of rotation of the rotor 1. Each of the torque receiving members 58 includes an anchor member 60 for facing the pads 10a and 10b, and a interconnecting member 61 for facing away from the pads 10a and 10b, the anchor member 60 and the interconnecting member 61 being integrally connected together by welding or the like. Opposite side surfaces of each interconnecting member 61, spaced from each other in the axial direction of the rotor 1, are defined respectively by flat surfaces parallel to a plane of the rotor 1. A pair of through holes 68 and 68 are formed respectively through two portions of each interconnecting member 61 (which are spaced from each other in a circumferential direction of the rotor 1), and extend from one of the opposite side surfaces thereof to the other, the axes of these through holes 68 being parallel to the axis of the rotor 1. Each of the anchor members 60 and 60 is formed by drawing in to a pillar-like configuration with a generally L-shaped cross-section. The interconnecting members 61 and 61 are fixedly connected at their one surfaces respectively to lengthwise-central portions of outer surfaces (serving as opposite end surfaces of the support member 3c in a direction of the width of the support member 3c) of the anchor members 60 and 60 by welding or the like, thereby forming the torque receiving members 58 and 58.

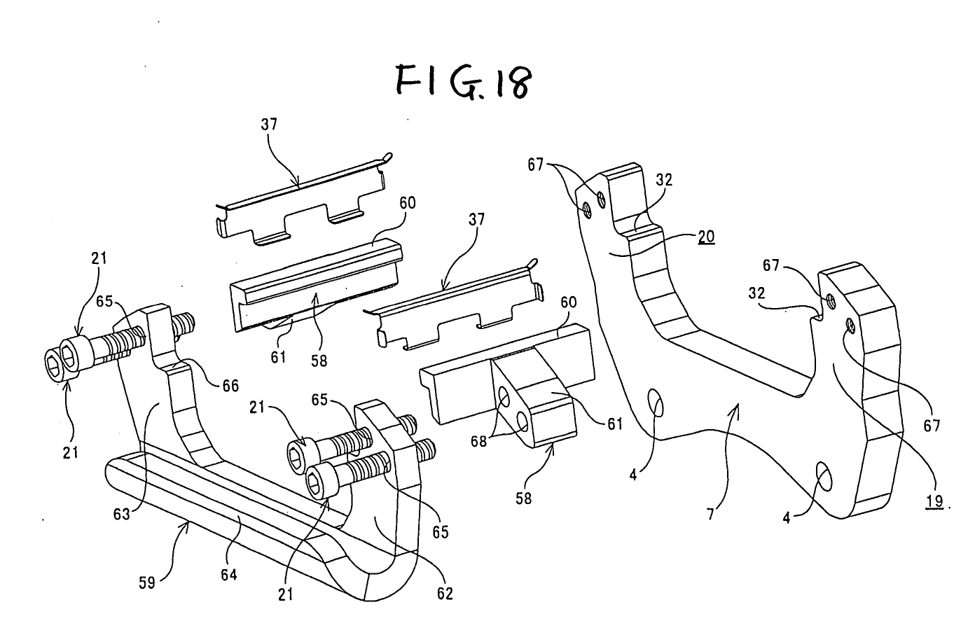

The outer-side reinforcing member 59 is formed by bending a metal plate (such as a rolled steel plate) having a uniform thickness, and has an integral construction. A run-in side arm portion 62 and a run-out side arm portion 63 are formed at one side portion of the outer-side reinforcing member 59, and are spaced from each other in the circumferential direction of the rotor 1. A reinforcing portion 64 is formed at the other side portion of the outer-side reinforcing member 59 by bending the relevant side portion thereof outwardly (in the radial direction of the rotor 1) into a U-shape. Two through holes 65 and 65 (FIG. 18) are formed through a distal end portion of each of the run-in side and run-out side arm portions 62 and 63 in a direction parallel to the axis of the rotor 1, and are aligned respectively with the through holes 68 and 68 formed in the interconnecting member 61 of the corresponding torque receiving member 58. Step portions 66 and 66 are formed respectively on inner surfaces (disposed close to a central portion of the support member 3c in the direction of the width thereof) of the run-in side and run-out side arm portions 62 and 63 at upper end portions thereof.

Two through holes 67 and 67 (FIG. 18) are formed through a distal end portion of each of run-in side and run-out side arm portions 19 and 20 (which form the inner-side mounting member 17) in a direction parallel to the axis of the rotor 1, and are aligned respectively with the through holes 68 and 68 formed in the interconnecting member 61 of the corresponding torque receiving member 58. The through holes 65 in the outer-side reinforcing member 59 are aligned with the respective through holes 68 (formed in the interconnecting members 61 and 61) and also with the respective screw holes 67 formed in the inner-side mounting member 17, and in this condition each of bolts 21 is passed sequentially through the through hole 65 and the through hole 68, and then is threaded into the screw hole 67, and is tightened. Thus, the inner-side mounting member 17, the torque receiving members 58 and 58 and the outer-side reinforcing member 59 are integrally connected together at a position disposed radially outwardly of the outer peripheral edge of the rotor 1.

Pad clips 37 and 37 are mounted respectively on inner surfaces of the torque receiving members 58 and 58 in such a manner that each pad clip 37 covers an inner surface of the anchor member 60 of the corresponding torque receiving member 58, an upper surface of the corresponding step portion 66 of the outer-side reinforcing member 59 and an upper surface of the corresponding step portion 32 formed at the upper end portion of the inner-side mounting member 17. The opposite end portions of each anchor member 60 (spaced from each other in the direction of the length thereof) project beyond the opposite sides of the interconnecting member 61 of the torque receiving member 58 respectively toward the outer-side reinforcing member 59 and the inner-side mounting member 17. The opposite end portions of each anchor member 60 (spaced from each other in the direction of the length thereof), extend respectively through the corresponding step portion 66 and step portion 32 (formed respectively at the outer-side reinforcing member 59 and the inner-side mounting member 17), and project respectively beyond the outer-side reinforcing member 59 and the inner-side mounting member 17. By a pad spring 49, engagement convex portions 33 and 33, formed respectively at opposite ends of each of the pads 10a and 10b, are resiliently pressed respectively against radially-outward surfaces (which are disposed outwardly in the radial direction of the rotor 1) of the inner surfaces of the anchor members 60 and 60 in a direction away from the axis of rotation of the rotor 1.

In this embodiment of the above construction, the support member 3c comprises the pair of torque receiving members 58 and 58, and the outer-side reinforcing member 59 disposed outwardly of the outer side of the rotor 1 in the axial direction of the rotor 1. Therefore, when the torque receiving portions for receiving a torque (acting in the direction of rotation of the rotor 1) from the inner pad 10a, are formed respectively as the torque receiving members 58 and 58 as in this embodiment, the outer-side reinforcing member 59 can be formed into a simple shape. Each of the torque receiving members 58 and 58 can also be easily formed into a simple shape, and an operation for machining those portions of the torque receiving members 58 and 58 which are to be connected or coupled to the outer-side reinforcing member 59, as well as an operation for machining those portions of the torque receiving members 58 and 58 for receiving the torque (acting in the direction of rotation of the rotor 1) from the pads 10a and 10b, can be carried out easily. As a result, the overall cost of the disc brake can be reduced. When there are prepared a plurality of kinds of torque receiving members 58 (anchor members 60) which are different in the thickness in the axial direction of the rotor 1, a plurality of kinds of disc brakes (which can be mounted respectively on a plurality of kinds of cars having respective rotors 1 of different thicknesses) can be obtained (that is, serialized brake models can be provided) while using the outer-side reinforcing member as a common part. In this case, the overall cost of the disc brake can be further reduced.

In this embodiment, the torque receiving members 58 and 58 and the outer-side reinforcing member 59 are connected together by the bolts 21 and 21 at the position disposed radially outwardly of the outer peripheral edge of the rotor 1. Therefore, the shape of the outer-side reinforcing member 59 can be easily made simpler, and the cost can be further reduced easily. And besides, the outer-side reinforcing member 59 is formed by the metal plate of a uniform thickness, and therefore the cost of the outer-side reinforcing member 59 can be further reduced easily. The outer-side reinforcing member 59 has the reinforcing portion 64 which is formed at the other side portion thereof by bending the relevant portion thereof. Therefore, with this inexpensive and lightweight construction, a gap can be secured between the support member 3c and its surrounding parts, and besides the strength of the support member 3 can be increased.

Each of the torque receiving members 58 and 58 includes the interconnecting member 61 interconnecting the inner-side mounting member 17 and the outer-side reinforcing member 59, and the anchor member 60 which is disposed closer to the pads 10a and 10b than the interconnecting member 61 is, and receives the torque (acting in the direction of rotation of the rotor 1) from the pads 10a and 10b. Therefore, the anchor members 60 and 60 do not need to be directly fixed to the inner-side mounting member 17 and the outer-side reinforcing member 59, and each anchor member 60 can be formed into a simple shape. Each of the interconnecting members 61 and 61 can be formed into a simple shape having parallel flat surfaces. Those portions of each torque receiving member 58 which are to be machined are the inner surface of the anchor member 60 (which receives the torque (acting in the direction of rotation of the rotor 1) from the pads 10a and 10b) and the opposite side surfaces of the interconnecting member 61 (facing away from each other in the axial direction of the rotor 1) which are connected respectively to the inner-side mounting member 17 and the outer-side reinforcing member 59. Before the anchor members 60 and 60 are joined to the interconnecting members 61 and 61, respectively, the inner surface of each anchor member 60 and the opposite side surfaces of each interconnecting member 61 can be machined, and therefore this machining operation can be easily carried out. As a result, the torque receiving members 58 and 58 can be produced at a low cost.

The anchor members 60 and 60 are disposed radially outwardly of the outer peripheral edge of the rotor 1, and the opposite ends of each anchor member 60 project from the opposite sides (side surfaces) of the interconnecting member 61 respectively toward the inner-side mounting member 17 and the outer-side reinforcing member 59. Therefore, the axial length of the anchor members 60 and 60 can be increased regardless of the thicknesses of the inner-side mounting member 17 and outer-side reinforcing member 59 and the distance between the two members 17 and 59. Therefore, for example, even when new pads 10a and 10b, having respective linings 15 of a large thickness, are used, so that the distance between the two members 17 and 59 is reduced, or when the thicknesses of the two members 17 and 59 are limited to below respective predetermined values, the pads 10a and 10b can be sufficiently engaged with the anchor members 60 and 60, and the shaking of the pads 10a and 10b can be suppressed. A caliper 2a is supported on the pads 10a and 10b through a guide pin 38, and therefore even if the opposite end portions of each pad 10a, 10b should be disengaged from the anchor members 60 and 60, the pad 10a, 10 will not be disengaged from the caliper 2a.

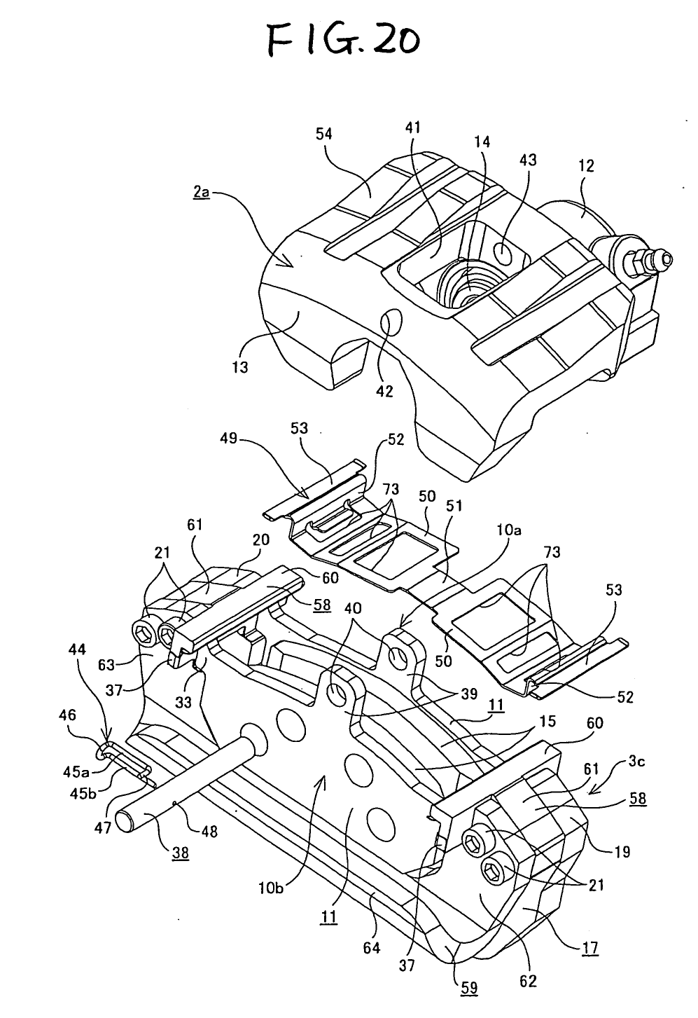

The other construction and operation are similar to those of the first embodiment of FIGS. 1 to 9, and therefore identical or similar portions are designated by identical reference numerals, respectively, and explanation thereof is omitted here. In this embodiment, however, a plurality of through holes 73 are formed through the hold spring 49 as shown in FIG. 20, and by doing so, a lightweight design of the hold spring 49 is achieved.

Although not shown in the drawings, in the structure of the third embodiment of FIGS. 11 to 20, the use of the inner-side mounting member 17 can be omitted, in which case as in the second embodiment of FIG. 10, via through holes formed in a plate portion 56 of a knuckle 55, this knuckle 55, the pair of torque receiving members 58 and 58 and the outer-side reinforcing member 59 are connected together by fastening means (such as bolts 21) at a position disposed radially outwardly of the outer peripheral edge of the rotor 1. In this case, the provision of the inner-side mounting member 17 can be omitted, and therefore the cost can be further reduced easily.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A floating caliper type disc brake comprising:
a support member fixed to a vehicle body and disposed adjacent to a rotor;
a pair of pads disposed on respective sides of the rotor;
a caliper supported on the support member and movable in an axial direction of the rotor, wherein the caliper includes a bridge portion straddling the rotor;
a claw portion provided on the caliper at one side of the bridge portion in the axial direction; and
a piston fitted on the caliper at the other side of the bridge in the axial direction,
wherein the support member comprises:
an inner-side mounting member disposed inwardly of an inner side of the rotor in the axial direction; and
one member that is separated from the inner-side mounting member, wherein the inner-side mounting member and the separate member are connected together at a position disposed radially outwardly of an outer peripheral edge of the rotor.

2. The floating caliper type disc brake according to claim 1, wherein the inner-side mounting member is formed by a plate material having a uniform thickness.

3. A floating caliper type disc brake comprising:
a support member fixed to a vehicle body and disposed adjacent to a rotor;
a pair of pads disposed on respective sides of the rotor;
a caliper supported on the support member and the pads and movable in the axial direction, wherein the caliper includes a bridge portion straddling the rotor;
a claw portion provided on the caliper at one side of the bridge portion in the axial direction; and
a piston fitted on the caliper at the other side of the bridge portion in the axial direction,
wherein the support member comprises:
a torque receiving member that receives a torque in a rotational direction of the rotor at a position disposed radially outwardly of an outer peripheral edge of the rotor, wherein the torque is transmitted from the pads during the braking operation; and
an outer-side reinforcing member disposed outwardly of the outer side of the rotor in the axial direction.

4. The floating caliper type disc brake according to claim 3, wherein the caliper is supported by guide portions formed at the support member and the pads, and by a guide member fitted in the guide portions of the pads.

5. The floating caliper type disc brake according to claim 3, wherein the torque receiving member and the outer-side reinforcing member are connected together at a position disposed radially outwardly of the outer peripheral edge of the rotor.

6. The floating caliper type disc brake according to claim 3, wherein the outer-side reinforcing member is formed by a plate material having a uniform thickness.

7. The floating caliper type disc brake according to claim 3, wherein the torque receiving member can be connected to the vehicle body at a position disposed radially outwardly of the outer peripheral edge of the rotor.

8. A floating caliper type disc brake comprising:
a support member fixed to a vehicle body and disposed adjacent to a rotor;
a pair of pads disposed on respective sides of the rotor;
a caliper supported on the support member and the pads and movable in the axial direction, wherein the caliper includes a bridge portion straddling the rotor;
a claw portion provided on the caliper at one side of the bridge portion in the axial direction; and
a piston fitted on the caliper at the other side of the bridge portion in the axial direction,
wherein the support member comprises:
an inner-side mounting member disposed inwardly of the inner side of the rotor in the axial direction; and
a torque receiving member that receives a torque in a rotational direction of the rotor transmitted from the pads during the braking operation, wherein the inner-side mounting member and the torque receiving member are connected together by fixing means or fastening means.

9. The floating caliper type disc brake according to claim 8, wherein the caliper is supported by guide portions formed at the support member and the pads, and by a guide member fitted in the guide portions of the pads.

10. The floating caliper type disc brake according to claim 8, wherein the torque receiving member comprises:
an interconnecting member interconnecting two members disposed respectively at the inner and outer sides of the rotor in the axial direction; and
an anchor member which is disposed closer to the pads than the interconnecting member, and receives the torque.

11. The floating caliper type disc brake according to claim 10, wherein the anchor member is disposed at a position disposed radially outwardly of the outer peripheral edge of the rotor, and opposite end portions of the anchor member project beyond the interconnecting member respectively toward the two members which are connected to the interconnecting member respectively at the inner and outer sides of the rotor.

12. A floating caliper type disc brake comprising:
a support member fixed to a vehicle body and disposed adjacent to a rotor;
a pair of pads disposed on respective sides of the rotor;
a caliper supported on the support member and the pads and movable in the axial direction, wherein the caliper includes a bridge portion straddling the rotor;
a claw portion provided on the caliper at one side of the bridge portion in the axial direction; and
a piston fitted on the caliper at the other side of the bridge portion in the axial direction,
wherein the support member comprises:
a torque receiving member that receives a torque in a rotational direction of the rotor transmitted from the pads during the braking operation; and
an outer-side reinforcing member disposed outwardly of the outer side of the rotor in the axial direction, wherein the torque receiving member and the outer-side reinforcing member are connected together by fixing means or fastening means.

13. The floating caliper type disc brake according to claim 12, wherein the caliper is supported by guide portions formed at the support member and the pads, and by a guide member fitted in the guide portions of the pads.

14. The floating caliper type disc brake according to claim 12, wherein the torque receiving member can be connected to the vehicle body at a position disposed radially outwardly of an outer peripheral edge of the rotor.

15. The floating caliper type disc brake according to claim 12, wherein the torque receiving member comprises:
an interconnecting member interconnecting two members disposed respectively at the inner and outer sides of the rotor in the axial direction; and
an anchor member which is disposed closer to the pads than the interconnecting member, and receives the torque.

16. The floating caliper type disc brake according to claim 15, wherein the anchor member is disposed at a position disposed radially outwardly of the outer peripheral edge of the rotor, and opposite end portions of the anchor member project beyond the interconnecting member respectively toward the two members which are connected to the interconnecting member respectively at the inner and outer sides of the rotor.

17. A floating caliper type disc brake comprising:
a support member fixed to a vehicle body and disposed adjacent to a rotor;
a pair of pads disposed on respective sides of the rotor;
a caliper supported on the support member and the pads and movable in the axial direction, wherein the caliper includes a bridge portion straddling the rotor;
a claw portion provided on the caliper at one side of the bridge portion in the axial direction; and
a piston fitted on the caliper at the other side of the bridge portion in the axial direction,
wherein the support member can be connected to the vehicle body at a position disposed radially outwardly of an outer peripheral edge of the rotor.

18. The floating caliper type disc brake according to claim 17, wherein the caliper is supported by guide portions formed at the support member and the pads, and by a guide member fitted in the guide portions of the pads.

19. The floating caliper type disc brake according to claim 1, further comprising: a resilient member, wherein opposite end portions of each of the pads are resiliently pressed against the support member in a direction away from an axis of rotation of the rotor.

20. The floating caliper type disc brake according to claim 3, further comprising: a resilient member, wherein opposite end portions of each of the pads are resiliently pressed against the support member in a direction away from an axis of rotation of the rotor.

21. The floating caliper type disc brake according to claim 8, further comprising: a resilient member, wherein opposite end portions of each of the pads are resiliently pressed against the support member in a direction away from an axis of rotation of the rotor.

22. The floating caliper type disc brake according to claim 12, further comprising: a resilient member, wherein opposite end portions of each of the pads are resiliently pressed against the support member in a direction away from an axis of rotation of the rotor.

23. The floating caliper type disc brake according to claim 17, further comprising: a resilient member, wherein opposite end portions of each of the pads are resiliently pressed against the support member in a direction away from an axis of rotation of the rotor.

24. The floating caliper type disc brake according to claim 1, wherein the caliper is supported on the pads by at least two guide portions respectively formed at the pads and a guide member fitted in the guide portions, in such a manner that the caliper is movable in the axial direction, and
the pads can slide relative to the support member in the axial direction while the displacement of the pads in a radial direction of the rotor is limited.

25. The floating caliper type disc brake according to claim 3, wherein the caliper is supported on the pads by at least two guide portions respectively formed at the pads and a guide member fitted in the guide portions, in such a manner that the caliper is movable in the axial direction, and
the pads can slide relative to the support member in the axial direction while the displacement of the pads in a radial direction of the rotor is limited.

26. The floating caliper type disc brake according to claim 8, wherein the caliper is supported on the pads by at least two guide portions respectively formed at the pads and a guide member fitted in the guide portions, in such a manner that the caliper is movable in the axial direction, and
the pads can slide relative to the support member in the axial direction while the displacement of the pads in a radial direction of the rotor is limited.

27. The floating caliper type disc brake according to claim 12, wherein the caliper is supported on the pads by at least two guide portions respectively formed at the pads and a guide member fitted in the guide portions, in such a manner that the caliper is movable in the axial direction, and
the pads can slide relative to the support member in the axial direction while the displacement of the pads in a radial direction of the rotor is limited.

28. The floating caliper type disc brake according to claim 17, wherein the caliper is supported on the pads by at least two guide portions respectively formed at the pads and a guide member fitted in the guide portions, in such a manner that the caliper is movable in the axial direction, and
the pads can slide relative to the support member in the axial direction while the displacement of the pads in a radial direction of the rotor is limited.
